(19) United States
(12) Patent Application Publication
(10) Pub. No.: US 2026/0300892 A1
(43) Pub. Date: Oct. 1, 2026

(54) MONITORING AND STORING DATA IN A STRUCTURED DATA MODEL PERTAINING TO BUSINESS PROCESSES

(71) Applicant: Intelligent Lagoon Research Ltd, London (GB)

(72) Inventors: James Ballin, London (GB); Ian Hunt, Heathfield (GB); Michael Aichinger, Perg (AT); Stefan Janecek, Perg (AT); Richard Wollhofen, Perg (AT)

(21) Appl. No.: 19/577,569

(22) Filed: Mar. 25, 2026

(30) Foreign Application Priority Data
Mar. 29, 2025 (GB) 2504697.0

(51) Int. Cl. G06Q 10/067; G06F 16/22

(52) U.S. Cl. CPC G06Q 10/0674; G06F 16/2219

(57) ABSTRACT

Computing apparatus, methods, data structures, databases and software are disclosed for monitoring and storing data related to business processes using a structured data model that captures causal linkages in the process events. It features one or more processors and memory storing multiple stencils for various business processes. Each stencil is a structured program-code template that a processor uses to instantiate a process object, which tracks a process's progress through predefined canonical states. The stencils define a process graph with event-nodes and edges, incorporating domain-specific knowledge about the process's progression from an initial state to terminal states. Each edge has a probability weight and time interval. The apparatus includes attributes and schedule functions, mapping process states to events to signify increasing certainty in process progression. When executed, the processors use a process object manager to monitor events and update process states, storing data to enable reasoned responses to queries about probable future states of business processes. Computing apparatus, methods, and software are also disclosed to serve these queries by extracting relevant records from the database for a given query information time and determining, for a future query effect time the expected values for process attributes and the likelihood of that future reality materializing at the query effect time. Computing apparatus, methods, and software are also disclosed to serve these queries by extracting relevant records from the database for a given query information time, and using a Monte Carlo method, simulating the outcome of the processes at the query effect time for a plurality of simulated scenarios, and determining the values of attributes in the scenarios.

### TECHNICAL FIELD

This disclosure relates to computer systems for monitoring, storing and querying business process data.

### BACKGROUND

Computing apparatus for monitoring business processes are typically integrated systems that track, analyze, and optimize various business operations. These systems utilize data captured from a wide range of sources, such as enterprise resource planning (ERP) systems, customer relationship management (CRM) tools, and transactional databases.

Enterprises dedicate enormous effort to strategic planning, often with very long time horizons (sometimes decades), balancing uncertain supply and uncertain demand, with complex supply chains, making efficient use of capital, all the while managing the operational minutiae of everyday business. The Zachman model of Enterprise Architecture (EA, which we note is as much about understanding the structure of an organization as it is about IT) is based around the six interrogatives: what, who, where, how, when, and why? In a world of accelerating change, increasing complexity, and the increasing importance of factors outside the organization's control (e.g. scarcity of resources arising from climate change), how are these questions to be answered? There are very few interesting businesses which are not subject to an uncertain evolving future.

Thus it is vitally important and valuable for businesses to be able to plan for the future.

It is in this context the present disclosure has been devised

### SUMMARY OF THE DISCLOSURE

The present inventors have realized the following, by which current computing systems are limited in their ability to help business plan for the future. They struggle with the fact that events evolve as they affect our lives, businesses, and organizations. Specifically, the way these systems digitize evolving events as data is problematic. Digitizing an event means being able to capture, store (in a structured, machine-readable form), discover, interrogate, and serve information about it.

Events do not suddenly appear as finished articles out of nowhere and nor does data about them. They often first appear uncertain and indefinite, progress and mutate, and usually (but not always) increase in certainty and become more concrete. Events impact many parts of the business in space and time, and affect many systems and users as they evolve. Events and their data are dynamic and the certainty associated with them is neither binary nor guaranteed to be strictly increasing with time.

Unlike data concerning the past and present, data about the future is uncertain. This is illustrated in FIG. 1A and FIG. 1B. FIG. 1A illustrates a process by which a business “SMOOTHIE SHACK” periodically orders and takes delivery of apples. When this process is initiated by placing an order, the time at which those apples are received, how many, of what quality, and perhaps—if at all—is not certain. Eventually though, these apples manifest themselves in the business's systems: order management, accounts, inventory. Different stakeholders are affected at different moments: procurement, accounts, warehousing and stock control, and so on. The timeline shown in FIG. 1B illustrating the progress of the process illustrates that, as the apple ordering process in the SMOOTHIE SHACK evolves, so our view of the eventual data continuously adjusts. That is, over time, our view of whether and when the apples may arrive, and how many of those apples may be good, may evolve as new information is received, up to the point where the apples are actually received and counted.

Thus regarding future events in a process, we can not only be uncertain about the timing and values (‘spatial’ attributes) of the event, but the event (and therefore the data) may not happen at all. That is to say that it may be path-dependent. Further, the future gradually becomes the present which becomes the past; it is not fixed and cannot be paused.

Notwithstanding that historic processes may be subject to data corrections, historical data has the convenient property that it stays historical; the same cannot be said for future data.

Digitizing an event means being able to capture, store (in a structured, machine-readable form), discover, interrogate, and serve information about it. However, digitizing the future as data is extremely difficult if our approach to doing so is based on techniques used to digitize the past where the time evolution has finished and the certainty and path-dependence have all been resolved. We refer to this conventional approach and assumptions around it as static data.

Static data is defined by its fixed timing, fixed value, and arbitrary certainty. It does not capture time evolution, variation, or uncertainty.

With static data, digitization is and will remain incomplete. Systems, such as they are today based around static data, are very good at digitizing the past and present. However, the future of a business, which is chronically afflicted by uncertainty, is not well digitized.

Forecasting is not the problem per se: there are plenty of tools to help with forecasting ranging from deterministic planning tools to complex simulations. The issue is that static data does not capture these forecasts in a universally accessible form alongside data pertaining to the past and present. Therefore, these forecasts are invisible to many users in an organization and limit effective, timely, holistic decision making. This reduces the value of these forecasts, limits what users can do, and what they can know.

The nature of forecasting based on static data in current enterprise systems is often disconnected, aggregated, and highly restricted in terms of the business variables that can be forecasted. It is disconnected because it usually involves the extraction of another monostate into a separate ‘tool’ (e.g. CSV into Excel, again with potential for compromising integrity), aggregated because the tool cannot understand the specific line-item detail, and frequently restricted to financial planning (cash and cash equivalents). Snapshots of single realities, that is, a single presumed outcome of an event, are an extremely limiting way to communicate information about the future. There is much to be understood about events that are still evolving and events that have barely begun without having to resort to statistical predictions.

We should also note that decisions made today can only affect the future. If software and digital systems are to enable truly effective data-driven decision making (DDDM), then it is imperative that they capture this law. Static data principally describes the past. To understand the possible future consequences of decisions, the static data model cannot readily help with this.

While single programs and individual applications based on static data may be appropriate for addressing particular events, or a portion of any particular event's lifecycle, these assumptions present an enormous problem for enterprise applications and enterprise users. Attempts to improve the visibility of future event data in software, rooted in static data, are complicated, buggy, and expensive to develop. Enterprises are distinguished by the size, complexity, and diversity of their activities, and hence heterogeneity of events and processes, and the cost of developing and maintaining software around static data in these situations is enormous.

Static data is fundamentally flawed because of its limiting assumptions and requirements:
Certainty of timing;
Certainty of value;
Certainty of existence;
No evolution through time.

The symptoms of static data manifest as:

1. Invisibility: Limits users and burdens developers with managing state

2. Snapshots: Monostate monotemporal crystallized views of single realities

3. Reconciliations: Multiple incoherent partial views

4. Compromised data integrity

5. Inconsistent computational performance and restricted temporal views

6. Monolithic architectures and inflexible systems

The consequences of static data are summarized below.

Limited visibility, especially into the future:
Static data primarily captures past and present states
Future states are poorly represented (often as singular, crystallized views) or entirely absent
Business systems and users struggle to anticipate and prepare for upcoming changes
Restricted and incomplete views of historic states limit our ability to reconstruct and learn

Ineffective communication:
Stakeholders' views (derived from outputs available from software) often diverge as situations evolve
Overcoming this requires constant synchronization efforts (reconciliations, emails, meetings, etc.)
Siloed, uncoordinated decision-making is all but unavoidable

Discontinuous changes in certainty:
Data appears in systems only when applications are ready for it
Results in artificial jumps in the availability of information
Consumers (whether humans, software, or AI) are unable to exploit information which, while possibly incomplete or uncertain, has value

Friction in the data lifecycle:
Static data does not capture the evolving and behavioral nature of business processes
It is difficult to capture and exploit the gradual materialization of information
Static data lacks representation of uncertainty, changing probabilities and emergent possibilities, whether opportunities or threats

Complicated, expensive software:
Systems exchange information through periodic snapshots of static data and reconciliations
Increases risk of compromising data integrity during updates or exchanges
Creates latency and inflexibility
Whether monolithic or microservice-based, this complicates system architectures, increasing cost of development and maintenance

Static data creates an artificial barrier to visibility of the future. Certainty of events constrains visibility of them. If the future were certain in respect of timing, value, and possibility (no path-dependence), and if time stood still, then static data would not be so limiting. However none of those assumptions hold true, or are even close to being true. To digitize events does not have to mean creating and maintaining immobile, singular, crystallized views of events, yet that is what static data does. Consequently, current systems have digitized the easy but much less valuable half of the timeline of business events and data, i.e. the historical half.

To this end, the present disclosure provides computing apparatus, methods, and computer program products, incorporating a structured data model that includes a causal model of how data behaves and evolves in the future, despite uncertainty.

Viewed from one aspect, the present invention provides computing apparatus for monitoring and storing data in a structured data model pertaining to business processes, the structured data model capturing causal linkages in events making up the processes and being usable to serve reasoned responses to queries on how the data may evolve to possible and probable future states of the business processes. The computing apparatus comprises: one or more processors; and memory storing: a plurality of stencils, each stencil being for one of a plurality of business processes, each stencil being a homogeneously structured program-code template by which a processor may instantiate a process object to monitor progress of a process through a sequence of a predefined number of at least two discretized canonical states universal to each stencil for all modelled processes. The stencil defining a process graph for the modelled process represented by the stencil, the process graph comprising event-nodes representing: events to be received by the computing apparatus in use as data messages in a stream or queue; or the absence of receipt of a given event within a time interval; wherein the events selected for the process graph include or infer information updating knowledge concerning the progress of the modelled business process. The process graph further comprising edges joining the event-nodes, the edges representing possible causal linkages of possible transitions between events. The process graph is arranged as a directed root tree encoding domain-specific prior knowledge about how the business process propagates from a root event-node at which the process is in a first, initial state to one or more leaf event-nodes defining one or more terminal mutually exclusive possible realities in which the process is considered to be in a final, done state, each edge being assigned a weight indicating the expected probability of monitored instances of the process transitioning from one event to another along a path to a given reality, each edge being further assigned a time interval within which the process is expected to traverse the edge to transition between the intersecting event-nodes. The stencil also defining one or more attributes for the modelled process; and a respective schedule function for each attribute and for the process, each schedule function specifying a mapping of states to events in the event-nodes of the process graph causing a transition of the respective attribute or process to a corresponding state, wherein the states in sequence represent indicators of increasing certainty about the progress of the processes and their attribute values from the initial state of the process to the final, done state of the process.

The memory further storing instructions which when executed cause one or more of the processors to implement a process object manager to: monitor events received as messages in a stream or queue; in response to receipt of any event matching an event-node in the process graph of a stencil for a given business process, instruct a process object instantiated for the process based on the stencil for that process to transition to the corresponding event-node in the process graph, thereby causing the process object to generate and store in a database record at least: a residual process graph including the remaining event-nodes and paths of the process graph of the stencil from the current event-node to the extant possible realities of the process stemming from the current event-node; respective state records for the process and each attribute. The state records storing: a timestamp representing the information time for the transition to the current event node; the current state of the process or attribute at the current event node, based on the schedule function for the process or the attribute; and for each attribute, a current expected value for each attribute of the process, updated based on information contained in the event and/or the stencil. The receipt of events for the business processes thereby generating a database of records digitizing data pertaining to the business processes and usable to serve reasoned responses to queries on how the data may evolve to possible and probable future states of the business processes.

The database records may thereby be usable to determine, for a given information time and based on the stored process graphs and attribute values, a forecast of the evolution of the monitored process for a future effect time. This is effectively through projecting the current data into the future through the process graphs to reveal a modelled probability distribution of the realities in which the process may be at the future effect time, and expected values for the attributes in those realities. This may include exploring modelled probability distributions for the attributes and expected transition times.

In embodiments, the stencils may be configured such that the process graph for each process may be configurable to may include one or more path splits occurring at one or more event-nodes, reflecting that in different process objects instantiated to monitor different instances of the process, data messages can be received that cause the process graph of the process object to diverge by transitioning along different paths to distinct realities in a path-dependent manner from the root event-node along edges through different event-nodes to one or more leaf event-nodes existing in different realities.

In embodiments, the distinct realities in a process graph may be indexed by a sequence of identifiers of the event-nodes in the path to that terminal event-node, the sequence of identifiers including at least those event-nodes at which path splits occurred, and wherein the instructions may be further configured to cause the process object to generate and store in each database record a record of the reality history for the monitored process and which may include the indexed sequence of identifiers to the current event-node.

In embodiments, the process graph may be configured such that, at an event-node from which the process splits and proceeds along one or more different edges on different paths to distinct realities, the path along which an instance of the process proceeds may be conditional on one or more criteria of the group, which may include a time at which the event may be received or by which the event may be not received, a value of some variable or attribute for the process prevailing at the time of receipt or non-receipt of the event, which of a set of mutually exclusive possible events may be received, and wherein the instructions may be further configured to cause the process object, when the process may be at an event-node from which the process splits, to selectively transition along the available paths based on the criteria for that event-node to the corresponding event-node in the process graph.

In embodiments, the process graph and attribute schedule functions may be configured such that each attribute belongs to a single reality such that, for that reality and realities stemming from all paths following from that reality, the attribute exists, and for processes that take a path that does not encompass the reality to which an attribute belongs, the existence of that attribute may be deemed incompatible with those other realities, and the schedule function maps the attribute to a vanished state.

In embodiments, the process graph may be constructed such that there may be a unique path through the process graph of event-nodes and edges to any event-node.

In embodiments, the process graph may be configured such that, within a reality the value of some variable, prevailing value of an attribute, of event data received for different instances of the process may fall within a range of tolerable possible values provided the causal consequences within the process may be deemed immaterial and lead to compatible and consistent outcomes within that reality, and between different realities the data received for the process may be such that the causal consequences within the process may be deemed materially different leading to mutually exclusive outcomes between the different realities.

In embodiments, the possible realities for a given process may be local to the process, and wherein the attribute values for the process within the possible realities may affect other, external processes.

In embodiments, the process graph may be configured to split at an event-node to transition along multiple paths that execute in parallel, wherein the paths of parallel execution may be at least initially in the same reality.

In embodiments, the stencil for each modelled process may include, for each event-node in the process graph, instructions defining a method as a function executable to initialize or update the expected value for attributes of the process based on information received in messages corresponding to events matching that event-node, wherein the methods in a stencil together constitute the domain model defined for the process, wherein the instructions may be further configured to cause the process object, when an event may be received corresponding to a transition to an event-node in the process graph for the monitored process, to call the method defined for that event-node passing arguments to the method based at least in part data related to the received event, the calling of the method optionally causing the process object to generate and store the record in the database.

In embodiments, each stencil may include instructions specifying an initialize method provided as the root event-node in the process graph corresponding to an event mapped to the first state in the schedule function for the process, the process graph thereby causing the initialize method to be called on instantiation of a process object based on the stencil to initialize a forecast of the expected values for all the attributes of the process.

In embodiments, for attributes not yet in the done state, the attributes may be defined as probability distributions that forecast the probability the attribute will take its different possible values when the attribute reaches the done state in the process, the expected value for the attribute being determinable based on the distribution, wherein the methods may optionally include instructions that, on being called, produce the probability distribution for one or more of the attributes.

In embodiments, the schedule functions for the process and each attribute construct the progress through the process as a state machine constructed as a directed acyclic graph, and having the states as nodes and the events representing the mapped event-nodes in the schedule functions as the edges, wherein the schedule function may be such that the state cannot go backwards in the state machine towards the root of the directed acyclic graph.

In embodiments, the instructions may further cause the process object to generate and store, in the state records for the process and each attribute in each database record, for any and all previous states of the process and attribute the previous state of the process or attribute, a timestamp of the information time the process or attribute transitioned to the previous state, and for each attribute, the expected value of the attribute of the process at the time of the transition to the previous state.

In embodiments, each generated database record itself encapsulates a complete bitemporal view of the process in its evolution over information time through the sequence of states up to the time the record was created, and, based on the stored process graph and attribute values, a forecast of the evolution of the monitored process for any future effect time.

In embodiments, the instructions may further cause the process objects to generate, as the record stored in the database, an immutable, denormalized block, the block record further may include if a block has previously been generated corresponding to a transition to an earlier event-node of the process, a reference to the most recently generated and stored block, the receipt of events for the monitored process thereby generating an append-only contiguous chain of immutable blocks as a record of the progress of the process, and each block being usable to determine, for at least the information time at which the block was generated, and based on the stored process graphs and attribute values, a forecast of the evolution of the monitored process for any future effect time.

In embodiments, the instructions may selectively cause each process object to transition the process to a quarantined state when: an event may be received in relation to the monitored process that may be out of sequence in the process graph, an event may be received in relation to the monitored process that may be incompatible with the current reality and any remaining possible realities modelled for the process in the process graph, when a time interval within which the process may be required to traverse the edge to the next event-node passes, without the corresponding event having been received.

In embodiments, the instructions may selectively cause each process object to automatically transition the process to a next event-node in the process graph when a time interval within which the process may be expected to traverse the edge to the next event-node passes, without the corresponding event having been received.

In embodiments, the computing apparatus may further include memory storing the database including the plurality of records generated by operation of any of the above-described computing apparatus.

Viewed from another aspect, the present invention provides a computing apparatus, optionally any of the above-described computing apparatus, for serving reasoned responses to queries on how data pertaining to business processes may evolve to possible and probable future states of the business processes. The computing apparatus includes one or more processors, and memory storing instructions which when executed cause one or more of the processors to implement a query manager to: for a query received in relation to one or more monitored business processes at a given query information time, as to the possible future states of the business processes at a query effect time later than the query information time, cause to be retrieved from a database a plurality of records, generated by operation of any of the above-described computing apparatus, of the state of progress of the business processes current at least until the query information time, the most recent data record for each queried business process at or before the query information time. The query manager also extracts from each retrieved data record all the attribute state records having a timestamp at or earlier than and nearest to the query effect time. The query manager also, for attributes indicated in the extracted attribute state records as being not yet in the done state, determines, based on: the schedule function for that attribute, the expected time of transitions based on the time intervals in paths in the residual process graph in the corresponding database record, and weights of edges in paths in the residual process graph in the corresponding database record, the reality the process may be scheduled to be in at the query effect time in which the attribute exists or the reality in which the attribute can no longer transition to a vanished state. The query manager also determines a modelled likelihood of that reality in which the attribute exists materializing at the query effect time based on a compound weight of the edges to that reality. The query manager also generates a query response that collates, for each attribute, at least the expected value for the attribute in the extracted attribute state record in the retrieved database records, the determined likelihood of the reality in which the attribute exists materializing at the query effect time, and optionally a scheduled effect state for the attribute at the query effect time determined based on the time intervals in the residual process graph.

In embodiments, for attributes indicated in the extracted attribute state records as being in the done state or for which there may be no future splitting left in the residual process graph, a likelihood of the reality in which the attribute exists materializing may be set to a weight of 1.

In embodiments, to determine the expected time of transitions based on the time intervals in paths in the residual process graph, the query manager may be further configured to, for time intervals in paths in the residual process graph that may be defined as floating time intervals, in which the process may be expected to transition to the next event-node along that path at any time within the floating time interval, determine the expected time at which the process may be expected to transition to the next event-node based on an appropriate probability distribution, optionally a uniform or normal or log-normal probability distribution, for the event occurring at different times during the floating time interval.

In embodiments, to determine a modelled likelihood of the reality in which the attribute exists materializing at the query effect time based on a compound weight of the edges to that reality, the query manager may be further configured to, for a query information time that intersects an edge in a path in the residual process graph having a time interval defined as a floating time interval in which the process may be expected to transition to the next event-node along that path at any time within the floating time interval, which edge, at the next event-node, leads to a time-based path split depending on whether or not the event may be received by the end of the time interval, where the event corresponding to the event-node has not yet been received by the query information time, calculate updated weights of the paths following the time split by determining, using Bayes theorem for the edge representing the event being received in time, the posterior probability of the event being received within the floating time interval taking into account the non-receipt of the event by the query information time, and for the edge representing the event not being received in time, the posterior probability of the event not being received within the floating time interval taking into account the non-receipt of the event by the query information time.

Viewed from another aspect, the present invention provides a computing apparatus, optionally any of the above-described computing apparatus, for serving reasoned responses to queries on how data pertaining to business processes may evolve to possible and probable future states of the business processes. The computing apparatus includes one or more processors and memory storing instructions which when executed cause one or more of the processors to implement a query manager to: for a query received in relation to one or more monitored business processes at a given query information time, as to the possible future states of the business processes at a query effect time later than the query information time, cause to be retrieved from a database a plurality of records, generated by operation of any of the above-described computing apparatus, of the state of progress of the business processes current at least until the query information time, the most recent data record for each queried business process at or before the query information time. The query manager extracts from each retrieved data record all the attribute state records having a timestamp at or earlier than and nearest to the query effect time. The memory may further include instructions which when executed cause one or more of the processors to implement a simulation module operable to, for attributes indicated in the extracted attribute state records as being not yet in the done state, and for each of a plurality of scenarios in a Monte Carlo method, determine, based on the schedule function for that attribute and the residual process graph in the corresponding database record, a simulated outcome of the modeled business process at the query effect time for that scenario by stepping forward through the edges and the nodes in the residual process graph to simulate the progress of that modeled business process in that scenario by, for each edge, determining a time at which the process may be simulated in that scenario to transition along the edge to the next event-node in the residual process graph by randomly sampling from an appropriate probability distribution for the time at which the process may be expected to transition to the next event-node, and resolving any time splits based on the determined time, and, for each event-node at which the path splits, determining a path which the process may be simulated in that scenario to take by selecting, based on a random sample, a path based on the weights of edges following the split. The simulation module further determines, for the simulated progress of the modeled business process in that scenario, the reality the process may be scheduled to be in at the query effect time and a simulated value for all attributes in that reality based on the expected values, or by sampling a probability distribution for the attribute value. The query manager generates a query response that collates, for each attribute and for each scenario, should the path taken by the scenario encompass the existence of the attribute, the simulated value for the attribute at the query effect time, and optionally a simulated effect state for the attribute at the query effect time determined by the attribute schedule function and the simulated path through the residual process graph.

In embodiments, stepping forward through the edges and the nodes in the residual process graph to simulate the progress of that modeled business process in that scenario may further include calling methods at each event-node encountered in that scenario to update the expected values of the attributes or the probability distributions for the attribute values.

Viewed from another aspect, the present invention provides a computer-implemented method for monitoring and storing data in a structured data model pertaining to business processes, the structured data model capturing causal linkages in events making up the processes and being usable to serve reasoned responses to queries on how the data may evolve to possible and probable future states of the business processes, the computer having access to a plurality of stencils, each stencil being for one of a plurality of business processes, each stencil being a homogeneously structured program-code template by which a processor may instantiate a process object to monitor progress of a process through a sequence of a predefined number of at least two discretized canonical states universal to each stencil for all modelled processes. Each stencil defining a process graph for the modelled process represented by the stencil, the process graph including event-nodes representing events to be received by the computing apparatus in use as data messages in a stream or queue, or the absence of receipt of a given event within a time interval, wherein the events selected for the process graph include or infer information updating knowledge concerning the progress of the modelled business process, and edges joining the event-nodes, the edges representing possible causal linkages of possible transitions between events, wherein the process graph may be arranged as a directed root tree encoding domain-specific prior knowledge about how the business process propagates from a root event-node at which the process may be a first, initial state to one or more leaf event-nodes defining one or more terminal mutually exclusive possible realities in which the process may be considered to be in a final, done state, each edge being assigned a weight indicating the expected probability of monitored instances of the process transitioning from one event to another along a path to a given reality, each edge being further assigned a time interval within which the process may be expected to traverse the edge to transition between the intersecting event-nodes. Each stencil further defining one or more attributes for the modelled process. Each stencil defining a respective schedule function for each attribute and for the process, each schedule function specifying a mapping of states to events in the event-nodes of the process graph causing a transition of the respective attribute or process to a corresponding state, wherein the states in sequence represent indicators of increasing certainty about the progress of the processes and their attribute values from the initial state of the process to the final, done state of the process. The computer-implemented method includes: monitoring events received as messages in a stream or queue; and, in response to receipt of any event matching an event-node in the process graph of a stencil for a given business process, instructing a process object instantiated for the process based on the stencil for that process to transition to the corresponding event-node in the process graph, thereby causing the process object to generate and store in a database record at least: a residual process graph including the remaining event-nodes and paths of the process graph of the stencil from the current event-node to the extant possible realities of the process stemming from the current event-node; respective state records for the process and each attribute, the state records storing a timestamp representing the information time for the transition to the current event node, the current state of the process or attribute at the current event node, based on the schedule function for the process or the attribute; and, for each attribute, a current expected value of the or each attribute for the process, updated based on information contained in the event and/or the stencil. The receipt of events for the business processes thereby generating a database of records digitizing data pertaining to the business processes and usable to serve reasoned responses to queries on how the data may evolve to possible and probable future states of the business processes.

Viewed from another aspect, the present invention provides a computer program product including instructions which, when the program is executed by a computer, cause the computer to carry out the above-described method. Viewed from another aspect, the present invention provides a computer-readable medium having stored thereon the computer program product.

Viewed from another aspect, the present invention provides a database including a plurality of records, for storage in a computer readable medium, the plurality of records being generated by the above-described method, the database of records digitizing data pertaining to the business processes and usable to serve reasoned responses to queries on how the data may evolve to possible and probable future states of the business processes. The database of records may also be usable to serve reasoned responses to queries on how the data has evolved to historic and current states of the businesses. Viewed from another aspect, the present invention provides a computer readable medium having stored thereon the database.

Viewed from another aspect, the present invention provides a computer readable medium storing a plurality of stencils defining a structured data model for storing data pertaining to business processes, the structured data model capturing causal linkages in events making up the processes and being usable to serve reasoned responses to queries on how the data may evolve to possible and probable future states of the business processes, each stencil being for one of a plurality of business processes, each stencil being a homogeneously structured program-code template by which a processor may instantiate a process object to monitor progress of a process through a sequence of a predefined number of at least two discretized canonical states universal to each stencil for all modelled processes. The stencil defining a process graph for the modelled process represented by the stencil, the process graph may include event-nodes representing events to be received by the computing apparatus in use as data messages in a stream or queue, or the absence of receipt of a given event within a time interval, wherein the events selected for the process graph include or infer information updating knowledge concerning the progress of the modelled business process, and edges joining the event-nodes, the edges representing possible causal linkages of possible transitions between events, wherein the process graph may be arranged as a directed root tree encoding domain-specific prior knowledge about how the business process propagates from a root event-node at which the process may be in a first, initial state to one or more leaf event-nodes defining one or more terminal mutually exclusive possible realities in which the process may be considered to be in a final, done state, each edge being assigned a weight indicating the expected probability of monitored instances of the process transitioning from one event to another along a path to a given reality, each edge being further assigned a time interval within which the process may be expected to traverse the edge to transition between the intersecting event-nodes. The stencil further defining one or more attributes for the modelled process. The stencil further defining a respective schedule function for each attribute and for the process, each schedule function specifying a mapping of states to events in the event-nodes of the process graph causing a transition of the respective attribute or process to a corresponding state, wherein the states in sequence represent indicators of increasing certainty about the progress of the processes and their attribute values from the initial state of the process to the final, done state of the process.

It will be appreciated from the foregoing disclosure and the following detailed description of the examples that certain features and implementations described as being optional in relation to any given aspect of the disclosure set out above should be understood by the reader as being disclosed also in combination with the other aspects of the present disclosure, where applicable. Similarly, it will be appreciated that any attendant advantages described in relation to any given aspect of the disclosure set out above should be understood by the reader as being disclosed as advantages of the other aspects of the present disclosure, where applicable. That is, the description of optional features and advantages in relation to a specific aspect of the disclosure above is not limiting, and it should be understood that the disclosures of these optional features and advantages are intended to relate to all aspects of the disclosure in combination, where such combination is applicable.

### BRIEF DESCRIPTION OF THE DRAWINGS

Certain examples of the present disclosure will now be described, with reference to the accompanying drawings, in which:

FIG. 1A illustrates an example simple process graph modelling a business process for ordering apples in accordance with an aspect of the subject matter in accordance with one embodiment;

FIG. 1B illustrates an example timeline for an instance of the business process shown in the process graph of FIG. 1A, showing that, as the apple ordering process evolves, so our view of the eventual data adjusts as new information is received;

FIG. 2 shows a schematic illustration an example implementation of a computing apparatus in accordance with aspects of the present disclosure;

FIG. 3 shows a schematic illustration an example stencil for an Apple Order process in accordance with aspects of the present disclosure;

FIG. 4 shows the interpretation of the sequence of five canonical states used in accordance with aspects of the present disclosure;

FIG. 5 shows a schematic illustration an example progression of a probability distribution for an example attribute value with increasing certainty over time and higher state transitions through the progression of the process in accordance with aspects of the present disclosure;

FIG. 6 illustrates the progression of the Apples Order process through to the terminal reality in which the apples are delivered, showing the evolution of certainty in the process and attribute over time, in accordance with aspects of the present disclosure;

FIG. 7A illustrates an example process graph having a time split in accordance with aspects of the present disclosure;

FIG. 7B illustrates an example process graph having a ‘space’ split based on the attribute in accordance with aspects of the present disclosure;

FIG. 7C illustrates an example process graph having a split from mutually exclusive outcomes in accordance with aspects of the present disclosure;

FIG. 7D illustrates an example process graph having a combination of splits from time and space in accordance with aspects of the present disclosure;

FIG. 8A illustrates an example process graph splitting into different realities in accordance with aspects of the present disclosure;

FIG. 8B illustrates the example process graph shown in FIG. 8A splitting into further different realities in accordance with aspects of the present disclosure;

FIG. 8C illustrates the example process graph shown in FIG. 8B splitting into yet further different realities in accordance with aspects of the present disclosure;

FIG. 9A illustrates a further example process graph with a reality split in accordance with aspects of the present disclosure;

FIG. 9B illustrates the realities, events, and their expectation times for an example process following the process graph of FIG. 9A in accordance with aspects of the present disclosure;

FIG. 10 illustrates the tree of realities navigable for a the Apples Order process in accordance with aspects of the present disclosure;

FIG. 11 illustrates the schedule function for the process state for the ‘Apples Order’ process in state machine form in accordance with aspects of the present disclosure;

FIG. 12 illustrates an example business process monitoring and storage method in accordance with aspects of the present disclosure;

FIG. 13 illustrates an example database record generated by the business process monitoring and storage method shown in FIG. 12 in accordance with aspects of the present disclosure;

FIG. 14 illustrates an example chain of blocks generated for the monitored ‘Apple Order’ process in accordance with aspects of the present disclosure;

FIG. 15 illustrates an example query serving method in accordance with aspects of the present disclosure;

FIG. 16 illustrates an example joint probability table for a renormalised probability distribution using Bayes theorem in accordance with aspects of the present disclosure;

FIG. 17 illustrates an example simulation method in accordance with aspects of the present disclosure;

FIG. 18 illustrates the results of an example query in accordance with aspects of the present disclosure;

FIG. 19 illustrates the results of an example query in accordance with aspects of the present disclosure;

FIG. 20 illustrates the results of an example query in accordance with aspects of the present disclosure;

FIG. 21 illustrates the results of an example query in accordance with aspects of the present disclosure;

FIG. 22 illustrates the results of an example query in accordance with aspects of the present disclosure;

FIG. 23 illustrates the results of another example query in accordance with aspects of the present disclosure;

FIG. 24 illustrates the results of another example query in accordance with aspects of the present disclosure; and

FIG. 25 illustrates the results of yet another example query in accordance with aspects of the present disclosure;

### DETAILED DESCRIPTION

Hereinafter, examples of the disclosure are described with reference to the accompanying drawings. However, it should be appreciated that the disclosure is not limited to the described examples, and all changes and/or equivalents or replacements thereto also belong to the scope of the disclosure. The same or similar reference denotations may be used to refer to the same or similar elements throughout the specification and the drawings.

As used herein, the terms “have,” “may have,” “include,” or “may include” a feature (e.g., a number, function, operation, or a component such as a part) indicate the existence of the feature and do not exclude the existence of other features. Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

As used herein, the terms “A or B,” “at least one of A and/or B,” or “one or more of A and/or B” may include all possible combinations of A and B. For example, “A or B,” “at least one of A and B,” “at least one of A or B” may indicate all of (1) including at least one A, (2) including at least one B, or (3) including at least one A and at least one B.

As used herein, the terms “first” and “second” may modify various components regardless of importance and do not limit the components. These terms are only used to distinguish one component from another. For example, reference to a first component and a second component may indicate different components from each other regardless of the order or importance of the components.

It will be understood that when an element (e.g., a first element) is referred to as being (physically, operatively or communicatively) “coupled with/to,” or “connected with/to” another element (e.g., a second element), it can be coupled or connected with/to the other element directly or via a third element. In contrast, it will be understood that when an element (e.g., a first element) is referred to as being “directly coupled with/to” or “directly connected with/to” another element (e.g., a second element), no other element (e.g., a third element) intervenes between the element and the other element.

The terms as used herein are provided merely to describe some embodiments thereof, but not to limit the scope of other embodiments of the disclosure. It is to be understood that the singular forms “a,” “an,” and “the” include plural references unless the context clearly dictates otherwise. All terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The weight is a forward-looking property of the (residual) process graph, calculated for the path to the reality where the attribute does not vanish from the current reality and current information state. The weight for an attribute is therefore related to the information state Si of the current reality, and is not a function of the effect state Se.

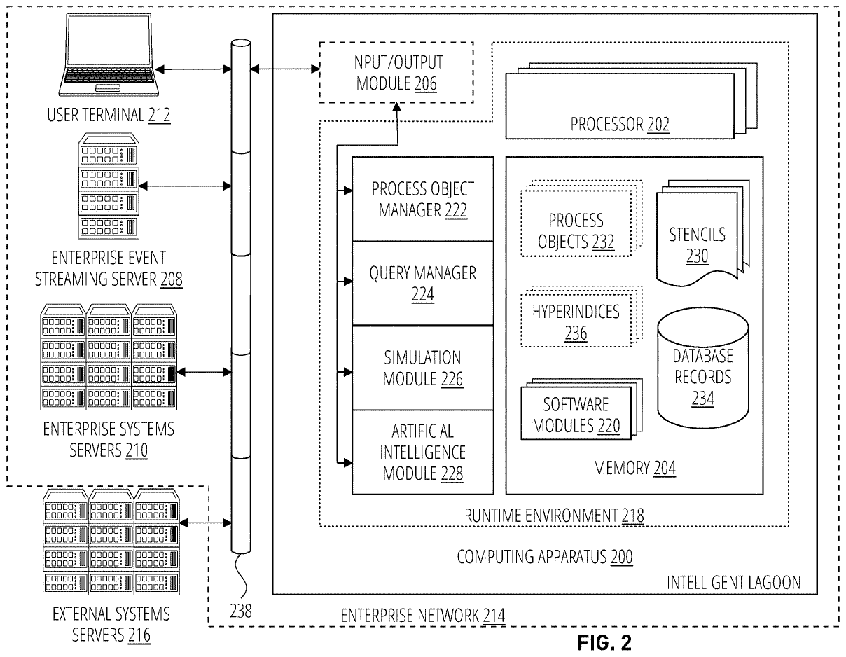

Reference will now be made to FIG. 2 which shows an example implementation of aspects of the present disclosure embodied in a computing apparatus 200 providing an “Intelligent Lagoon” business management software system for monitoring and storing data in a structured data model pertaining to business processes.

The example computing apparatus 200 includes one or more processors 202, memory 204 and an input/output module 206. A bus system (not shown) may be provided which supports communication between at the least one processor 202, memory 204 and input/output module 206.

The processor 202 executes instructions that can be loaded into memory 204. The processor 202 can include any suitable number(s) and type(s) of processors or other devices in any suitable arrangement. Example types of processor include microprocessors, microcontrollers, digital signal processors, field programmable gate arrays and application specific integrated circuits.

The memory 204 may be provided by any structure(s) capable of storing and facilitating retrieval of information (such as data, program code, and/or other suitable information on a temporary or permanent basis). The memory 204 can represent a random access memory or any other suitable volatile or non-volatile storage device(s). The memory 204 may also contain one or more components or devices supporting longer-term storage of data, such as a read only memory, hard drive, flash memory, or optical disc, which may store instructions in the form of software modules 220 for loading into the memory 204 at runtime. In use, the processor 202 and memory 204 provide a runtime environment 218 in which instructions loaded into the memory in the form of software modules 220 can be executed by the processor 202 to generate instances of software applications in the runtime environment 218.

The computing apparatus 200 also comprises input/output module 206 providing a communications interface for receiving, via a network such as an Enterprise network 214, data and instructions from one or more other network nodes including an Enterprise Event streaming Server 208, Enterprise systems servers 210 or User Terminal 212. The Enterprise network 214 may include one or more overlapping virtual networks for an enterprise supported by a plurality of physical networks, and secured as a virtual private network, to provide a secure perimeter for the enterprise systems and data. Within the Enterprise network 214, the User Terminal 212, Enterprise Event streaming Server 208 and Enterprise systems servers 210 communicate with each other and with the computing apparatus 200 through network connections 238, to provide data about events in processes of the business as inputs to the computing apparatus 200.

Although shown in FIG. 2 as a standalone computing apparatus, the computing apparatus 200 may be configured as one or more a networked servers or as a virtual machine implemented in a cloud computing and cloud storage environment supported by one or more data centers, any of which may be suitable for implementing the business management software system for monitoring and storing data in a structured data model pertaining to business processes as described herein.

Although shown as being within the Enterprise network 214 in FIG. 2, in alternative implementations, the computing apparatus 200 may actually exist outside the Enterprise network 214 and interface with the data sources within it, for example, using an API.

The computing apparatus 200 may participate in or implement a data pipeline for processing the events and other business data. The data provided to the data pipeline may include data which can be consumed as events relating to the business processes, and other augmenting data which may refine information about the existing events in the processes.

In the context of the present disclosure, events and processes are to be understood and consistently referred to as follows. Processes are matters that evolve through time and certainty towards completion or abandonment, whereas events are moments or occurrences in the evolution of the process. This remains consistent with accepted terminology. Various examples of business processes and the events that drive them forward, will be set out in the description below.

In the context of the present disclosure, a process represents how business data manifests in business systems as a real-world (macroscopic) business process evolves through its lifecycle. The business data is referred to as the attributes of the process.

As will be explained in more detail below, a process thus carries a set of attributes. Generally, certainty of these attributes will improve as events evolve and as the process progresses from initialization towards completion. Specification of a process requires the initial values of the attributes and the sequence of events that will drive the process forwards. That is, specification of a process should include information necessary to construct an initial view of the attributes (i.e. the arguments to call the forecasting functions). Initially the values of attributes and timings of successive events may be highly uncertain, but will usually become more definitive as events unfold.

A simple example of this is the number of passengers on an aircraft flight. When a flight is scheduled we take a view of how many passengers will be carried on the flight. As the aircraft is prepared and eventually departs, our view of how many passengers are carried becomes more definitive.

Processes are thus sequences of events which, when taken together, bring about some change or refinement in some attributes of assets or resources within the ecosystem of a business. Processes may be intended, in the context of a business, to coordinate activities to bring about some goal, which may be fulfilled on completion of the process. Events represent occurrences in these activities or updates in knowledge on the journey of a process towards its completion. Processes may involve or be conditional on activities by participants within the business and outside the business, such as upstream or downstream members of a supply chain, customers which may be individuals, businesses or other organizations, or unrelated third parties such as competitors, or may be dependent in some way on environmental factors such as the weather, or more abstracted factors such as economic occurrences or other incidental or natural occurrences, and not necessarily reliant on some human or organizational actor.

Significantly, as will be explained in more detail below, the processes are characterized in the business management software system implemented in computing apparatus 200 of the present disclosure by the use of process graphs which account for processes that progress in a possibly path-dependent manner to arrive at one of a number of possible different outcomes manifest as different, mutually exclusive realities. Further, the processes are characterized by schedule functions for the process and the attributes that relate the state of the process and its attributes to the progress through the process graphs. That is, process graphs and schedule functions are analytical tools used to codify the progression of a process through various states along one of a number of different possible paths, illustrating how the attributes, variables, timing of receipt and non-receipt of events regarding the progress of a process influences the evolution of the process into one of a number of different possible realities. They detail the path-dependent nature of processes, beginning from an initial state and evolving through a series of transitions to reach a final state. Such graphs accommodate the potential manifestation of multiple realities, as they account for different possible outcomes that may arise due to varying conditions. Process graphs thus specify a sequence of event- or time-based criteria to be satisfied such that the event can be deemed more complete, certain, and finished, and they also capture aspects of the process which are path-dependent, and therefore they specify the criteria under which of the various possible paths that diverge to different realities are selected (and others fall away). This allows for a comprehensive understanding of how complex processes unfold over time.

A process describes how business data becomes factual as the real-world event evolves. It is a lifecycle of the data. The real-world event may have many complex and interesting steps, activities, and so on, but if none of these have an impact on the business data (i.e. attributes) that need to be captured, then they do not need to be modelled in the process.

While the above understanding of processes and events is key to the business management software systems disclosed herein, it is unfortunate that approaches in current computing systems tend to assume that events are merely disconnected flashes of light in the darkness, and so they are not understood as forming part of a process. This is what events are to event driven architectures and streaming platforms like Apache Kafka™.

In this respect, data relating to events may be received at the computing apparatus 200 from Enterprise Event streaming Servers 208, which may implement an event-driven architecture platform like Apache Kafka™ or Amazon Web Services EventBridge™. The Enterprise Event streaming Servers 208 may provide a platform for direct support and event production for various business systems. Alternatively or in addition, the Enterprise Event streaming Servers 208 may provide a platform for monitoring other existing business systems to produce events therefrom. In this way, the Enterprise Event streaming Servers 208 generate a real time feed of data in the form of events or messages in an event stream. The Enterprise Event streaming Servers 208 may partition the produced events into different channels by marking them as relating to different topics. Different channels in the event stream may be subscribed to and monitored by consumers on the event stream to discover information about events relating to different business processes. The computing apparatus 200 may act as a consumer of the event stream and receive and process the events indicated thereby to monitor the progress of business processes from initialization to completion.

Alternatively, or in addition to receiving information about events from Enterprise Event streaming Servers 208 in an event driven architecture, the computing apparatus 200 may receive events from a User Terminal 212, which may be based on or as a result of user input thereat, or from Enterprise systems servers 210. Data relating to business processes may be periodically sent from the Enterprise systems servers 210 to the computing apparatus 200 by means of batch processing, on an ad hoc basis, or by extract, transform and load (ETL) processes. The batch exports of data from the Enterprise systems servers 210 to the computing apparatus 200 may occur automatically, or semi-automatically or manually under user control, for example by operation of User Terminal 212. Further still, data can be provided to the computing apparatus 200 from External systems servers 216, outside the Enterprise network 214 itself, which may include public, environmental or contextual data, such as weather data, market prices, and so on.

In the example, the memory 204 comprises instructions in the form of software modules 220 for instantiating computing applications in the runtime environment 218 including a process object manager 222, query manager 224, simulation module 226 and artificial intelligence module 228. A brief overview of the function and operation of these four software applications will now be summarized, at a high level.

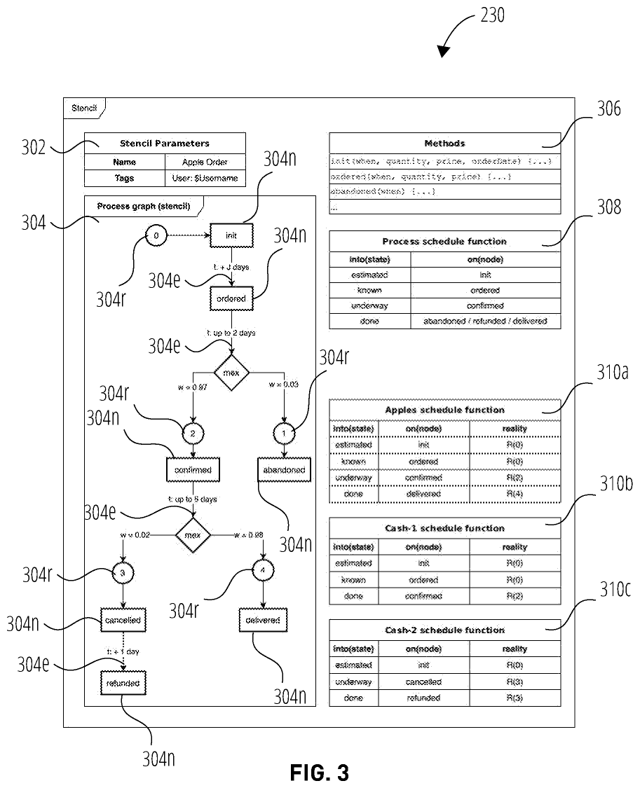

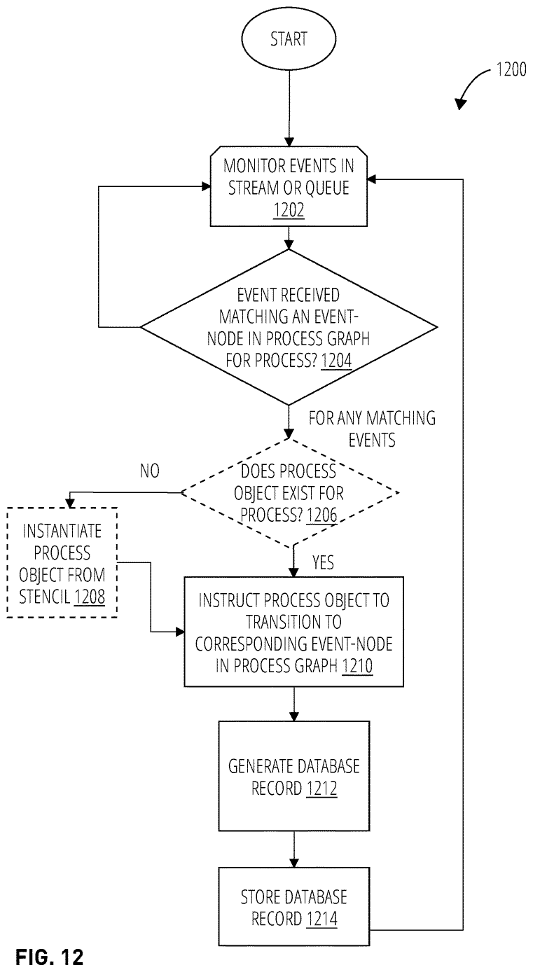

The process object manager 222 is for monitoring and storing data pertaining to business processes and will be described below with reference to FIG. 12. Generally, to understand the data received at the computing apparatus 200 relating to events, the process object manager 222 refers to a library of stencils 230 stored in the memory 204, each of which defines one of a plurality of business processes in terms of its attributes and mapping the events that progress the process from initialization to completion along a process graph. The definition of the stencils will be described below in particular with reference to FIG. 3. A stencil may be defined for each kind of process that the business is subject to. Process objects are instantiated from these stencils. Thus, when a new process to be monitored is ‘detected’ by the occurrence of an event in the event stream or queue by the process object manager 222, the process object manager 222 instantiates a process object 232 based on the stencil 230 corresponding to the business process. As the process objects 232 are instantiated in memory 204 based on the stencils 230, which are program-code templates, the process objects 232 may persist in memory only as long as the time from when the process object is instantiated (e.g. on the initialization of the process) and until the process object is closed (e.g. on completion or abandonment of the process). For that reason, the temporarily persisting process objects 232 are shown in dotted lines in the memory 204 in FIG. 2. In contrast, as the stencils 230 represent the permanent definition of the processes as program-code templates, these are stored in memory 204 persistently, to be drawn on as needed to instantiate process objects 232, and so the stencils 230 are shown as file objects in memory 204 in unbroken lines in FIG. 2.

As will be described, the process object 232 from there stores updates on the progress of the process in the form of database records. These database records may store the data in any suitable form, provided the structured data model described herein is retained in the stored database records. For example, the database may store the database records in a key-value store. A key-value store is a type of non-relational (NoSQL) database that uses a simple data model consisting of key-value pairs. Each key is unique within the database and is associated with a value that can be a simple data type, such as a string or number, or a more complex data structure like a JSON object or a list. This architecture allows for quick data retrieval through direct access via keys. Key-value stores are designed for high performance, scalability, and simplicity, making them suitable for applications requiring fast read and write operations, such as caching systems, session management, and real-time analytics. The database may be a document database (in the context of a key-value store, the stored values would be documents). A document database is a type of non-relational (NoSQL) database designed to store, retrieve, and manage document-oriented information. Documents in these databases are typically stored in formats such as JSON, BSON, or XML. Unlike traditional relational databases, document databases do not require a fixed schema, allowing for greater flexibility in handling heterogeneous and evolving data structures. Each document can contain complex data, including nested structures, and is identified by a unique key. This makes document databases particularly suitable for applications requiring efficient management of structured or semi-structured data with varying data formats.

In embodiments, including those described in detail herein, the database records 234 are stored as immutable, denormalized blocks. As the database records 234 are stored persistently whether in flash or persistent memory, they are intended to be immutable, and so the data store is shown in FIG. 2 in unbroken lines.

As will be explained in more detail below, the database records 234 record the state of the process and information about the progress of knowledge about the process over time, in block form. The stored database records 234 may allow forward looking and backward looking bitemporal queries of the process state viewed from different information times, as the process state was or is expected to be for any given effect time. Each database record may itself individually encapsulate a complete bitemporal view of the process in its evolution over information time through the sequence of states up to the time the record was created, and, based on the stored process graph and attribute values, a forecast of the evolution of the monitored process for any future effect time.

By building up a store of database records 234 as a process progresses through states of increasing certainty to completion, different views of the overall business can be easily reconstituted for any time, based on the aggregated state of its processes and their effects on the affected attributes of business resources and assets, in a way that is not readily achievable using existing technologies.

Operation of the computing apparatus 200 to monitor and store data in a structured data model pertaining to business processes will be described in more detail in relation to FIG. 12 to FIG. 14.

The query manager 224 is provided to serve queries against the database records 234. That is, in response to receipt of a query, the relevant database records may be identified and retrieved from the store of database records 234 by the query manager 224, which may then extract, process and collate relevant data in order to generate a response to the query.

To facilitate retrieval of the stored database records 234 at a later date, for example, to serve query manager 224 with database records relevant to a received query, the process object manager 222 may cause instances of hyperindexes 236 to be created monitor and index database records 234 that relate to the subject of the hyperindex. For example, the stencils 230 may define hyperindexes 236 to be notified of database record updates, and tags. This can allow a query manager 224 to be served with database records 234 relevant to a query in relation to a given query information time by finding, using the hyperindexes 236 identified by stencils as being relevant to a process or its attributes, the corresponding hyperindices which contain a log of the database records in the store of database records 234 relevant to the query at that information time, allowing them to be retrieved quickly. Alternatively any other suitable indexing system may be used that allows database records relevant to a query to be located and served to query manager 224. A detailed explanation of the database record indexing and retrieval mechanism is not needed here, and it is to be understood that the query manager 224 and other software modules 220 may be able to identify and retrieve desired database records from the store of database records 234 as needed.

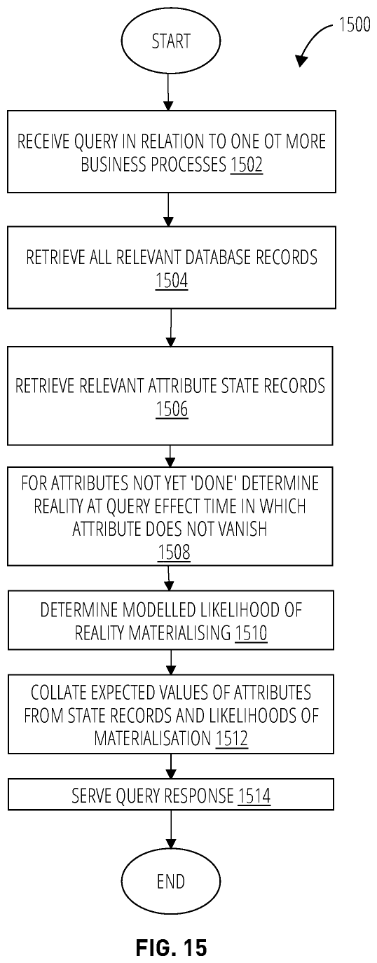

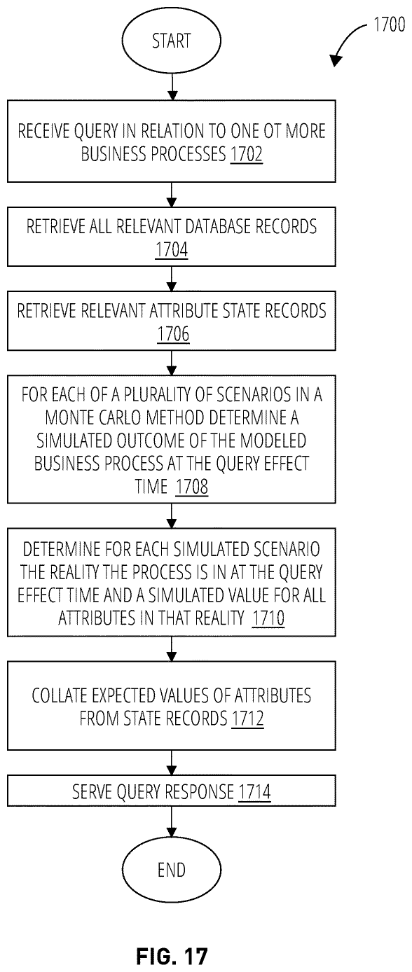

Two alternative but complementary approaches which can be implemented by the query manager 224 to extracting, processing and collating responses to queries based on the retrieved database records are described herein. The first approach, described below in relation to FIG. 15, expands the residual process graphs stored in the retrieved database records by stepping forward along the process graphs, by determining the expected times for transition of any floating time intervals times, to determine the expected realities at the query effect time and associated likelihoods of materializing. The second approach, described below in relation to FIG. 17, augments or can be used as an alternative approach to that shown in FIG. 12, by using a simulation module 226 to explore the spectrum of potential outcomes to reveal a probability distribution across the future states of the business processes at the query effect time, using a Monte Carlo method.

Specifically, these approaches use the forward looking ‘momentum’ of a process captured in the structured data model to provide forward looking projections of the possible outcomes for the business processes based on a set of database records. That is, for a set of database records retrieved and calibrated for a given query information time (which may be ‘now’, or any past point in time for which database records exist in the store of database records 234), these two approaches extract, process and collate information from the retrieved database records to provide an indication of the possible future states the business processes may be in (as understood as different possible realities) at a given query effect time, which is in the future relative to the query information time. In this respect, the database records 234 allow bitemporal queries against state and evolution of business processes over time (that is, the expected future evolution of the business processes can be explored, based on information known at any information time, current or past). In addition, these approaches determine a related likelihood of those realities materializing, revealing a probability distribution of potential future outcomes, as well as expected values for attributes of the processes (or actual, settled values, if the attribute or process are already in the final, done state).

This ‘Dynamic State Technology’, enabled by the computing apparatus 200 thus allows, for the first time, queries about future states of business processes to be served taking into account the possible momentum or direction of travel inherent with business processes as codified in their process graphs based on domain-specific prior knowledge. That is, the process graph is the data structure that allows the computing apparatus 200 to propagate the information contained about the business processes contained in the store of database records 234 forwards through time and space, accounting for uncertainty and path dependence. That is, the structured data model causes the database records 234 to encapsulate the expected dynamics of the progress of the associated process through different processes to completion in a range of possible outcomes, in a way that can be queried. Querying plural records together allows information about the dynamics of complex and interrelated business processes to be revealed, capturing expected timings, values, states and confidence levels.

Conventionally, a database storing static data cannot support queries against potential evolution of the static data as the database does not know or understand how data behaves. Normally, it's up to the application to effect changes in state. Dynamic State Technology allows the database to do this inherently. When the process graph is combined with the schedule functions, state, bitemporality, and path dependence, it has the very useful effect of making possible future data visible, even though it is not yet certain. Further, when combined with the storing of the database records 234 as append-only immutable data structures in the form of a linked list or chain of blocks, this also allows arbitrary views in time (any query effect time) for any point in the information stream (information time and query information time). And yet further, as will be explained later, this information can be recalibrated on-demand to account for the passage of time and non-receipt of information since it was last created or updated.

That is, using the Dynamic State Technology as disclosed herein, queries against the database records 234 can directly serve responses which reason over the data as the process graphs inherently capture causal linkages between events as the processes evolve and progress. Further, the data captures and can therefore serve information about the future state of certainty of business processes and attributes, to distinguish “it happened” (past) from “not happened yet” (future), or “it's an educated guess”, from “it's likely”, from “it's a settled fact”. Further, the database records 234 capture data and thus serve queries in a fully bitemporal manner, which distinguishes that time at which information about ‘something’ is known from the time that the ‘something’ takes effect. Further, still, the process graphs allow full support for queries to account for the conditional path-dependent nature of the progress of processes into different realities through inclusive and mutually exclusive conditions occurring along the way as the process evolves. In this way, data of diverse (a) certainty, (b) timing, and (c) possibly contradictory conditions for existence can exist in one database. Further, that data can be queried, on-demand, with unrestricted choices for these parameters. Further still, when the data is served to the user in response to queries, it is clear and explicit what the (a) certainty, (b) timing, and (c) conditions for its existence are. This capability is simply nonexistent with static data, conventional data structures, and database technologies.

Further, the storing of process data in this structured way enables machines, in particular artificial intelligence tools, to understand and reason over the data, allowing enterprise AI systems to deliver materially different outcomes and insights into the data, allowing for complex queries to be answered, or strategic decision making to be supported or even automated. To this end artificial intelligence modules 228 may be provided to interact with the database records 234, for example directly or through the query manager 224, to enable new business tools that inherently understand not just the current state of the business, but its direction of travel and expected possible future states, allowing future risks and opportunities to be visible, managed and capitalized on. Dynamic State Technology thus allows businesses to identify and solve potential problems before they materialize, as well as uncovering bottlenecks and other points of failure in a business's operations that would not otherwise be easily visible, thus providing a path to significantly improving overall business efficiency. Such strategic decision making and operational action can be overseen by a human in the loop, or fully automated, with a sufficiently trained agentic AI system.

The solution presented herein is thus a business management software system that does not assume the world is static in time and arbitrarily certain. Rather, it is software that understands that events evolve, that can perceive the effects of events from multiple perspectives of timing and certainty. Rather, this is captured and stored directly in the database records 234. It is an architecture that thus separates data from functionality and offers a universal source of truth, rather than impose a single view of truth. It is a platform that offers new degrees of freedom to applications and users (whether human or artificial), allowing them to get the view they need when they need it, rather than be forced to accept what they're given.

Before describing the operation of the process object manager 222, query manager 224, and simulation module 226 software applications of the business management software system, a description of the components underlying the structured data model of the Dynamic State Technology implemented in the business management software system will first be provided, including an explanation of the stencils 230, processes, events, attributes, states and process graphs.

FIG. 3 shows an example stencil 230, a plurality of which may be stored in memory 204. Each stencil is for one of a plurality of business processes. Specifically, each stencil is a homogeneously structured (meaning that all stencils comprise the same core components) program-code template by which the computing apparatus 200 may instantiate a process object to monitor a process, and store in a structured data model queryable for any process data pertaining to the process, including Dynamic State information capturing not just the current state of the process, but also information about how the process is expected to progress to one or more possible outcomes over time (and also information regarding how the process has progressed to date and come to arrive at its current state).

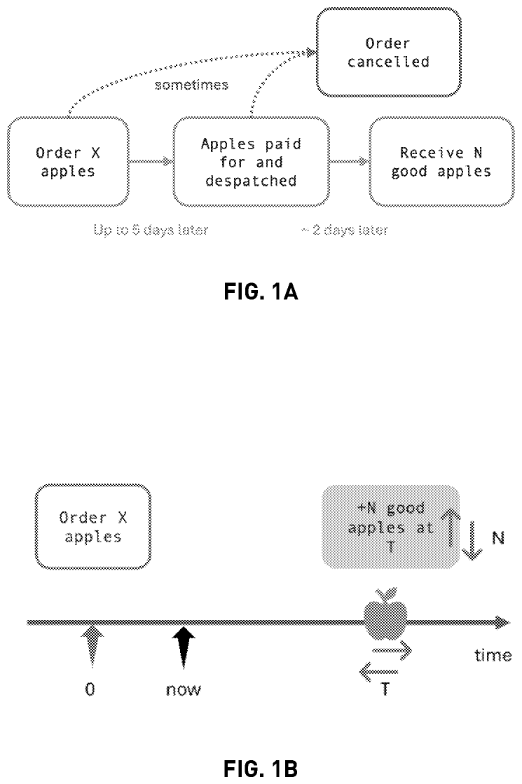

Each stencil includes parameters 302 such as a name used to identify the stencil 230. In this case, the stencil is named “Apple Order” as it is intended to model a business process such as that shown in FIG. 1A and FIG. 1B for ordering apples. The parameters 302 may also include one or more tags or hyperindexes usable, for example, to identify or characterize the method and its relevance, and usable to index data records generated from the stencil 230, to facilitate their later efficient retrieval.

Significantly, each stencil 230 includes a process graph 304 representing a model of how the process is expected to develop. In this respect, the process graphs encode domain-specific prior knowledge about the process they are configured to monitor, and may be generated or refined manually through known constraints or requirements, and/or expert knowledge, and/or using empiricism, and/or generated or refined using data through statistical analysis, process mining, or using other tools like artificial intelligence.

The process graph 304 comprises a plurality of event-nodes 304n joined to each other by edges 304e.

Each event-node 304n represents an event that is expected to be received by the computing apparatus 200 when in use as a data message in a stream or a queue, such as from Enterprise Event streaming Server 208, or the absence of receipt of a given event within a time interval (e.g. as defined for the edge incident on it). The events selected for the process graph include or infer information updating knowledge concerning the progress of the modelled business process. For example, for the ‘Apple Order’ process stencil 230 shown in FIG. 3, the possible event-nodes 304n that might be received in the course of a normal completed order include when the order is initialized, then ordered, then confirmed, then delivered.

The process graph 304 includes edges 304e joining the event-nodes 304n. The edges 304e represent possible causal linkages of possible transitions between events corresponding to the event-nodes 304n with which that edge is incident. For example, for the ‘Apple Order’ process stencil 230 shown in FIG. 3, the first event-node 304n corresponds to when the order is initialized (for example, when a new order is identified as being needed, creating a new order process). That is, the apple order is envisaged, but it has not yet been manifested. The process graph codifies in the data structure the expectation that, after the order has been initialized, the effect of this is that the order is expected to be placed as a next step. The process graph 304 progresses to the next event-node 304n when the apples have been ordered. That is, when the order has been placed to request delivery of apples at some future date.

A process evolves from first sight to completion as information is received, time passes, and criteria are met. The process graph specifies the information that the process may receive along any given path and the causal relationships between items of information. For example, for a process graph comprising an event-node “out of bed” joined by an edge to an earlier event-node “in shower”, receipt of the “in shower” event must mean that out-of-bed was previously true. The process graph 304 fully specifies the causal sequence of events and realities for the process it is designed to monitor. Anything falling outside of the process graph is an anomalous condition.

Each edge 304e in each process graph is assigned a time interval within which the process is expected to traverse the edge to transition between the intersecting event-nodes. After receipt of an event corresponding to an event-node, the process graph 304 waits on the subsequent edge leading from the event-node for the indicated time interval for further information in the form of an event or absence of an event (which is itself information) to transition to the corresponding next event-node.

These time intervals may be deterministic or expressed as distributions. Intervals must be finite with well-defined expectation values. The duration between nodes can be specified:
as a fixed duration (e.g. “3 days”);
as a floating duration (e.g. “up to 5 days”), where a probability distribution governs the timing of the event within the interval;
given that the subsequent node is at a fixed datetime (e.g. “next event: 2024-12-25”).

As explained below, the requirement for the (floating) intervals to be finite is essential to allowing them to be renormalized based on the passage of time absent receipt of information, described below in relation to recalibration of active floating time intervals.

In the process graph 304 shown in FIG. 3, the edge between event-nodes “cancelled” and “refunded” is annotated with a fixed time interval expected between them. Thus when the “cancelled” event is received, the process waits 1 day to receive the “refund” notification. That is, the process expects the refund to be received in +1 day.

However, the edge between event-nodes “confirmed” and “delivered” is annotated with a floating time interval expected between them. Thus when the “confirmed” event is received, the process waits up to 5 days to receive the “delivered” notification. That is, the process expects the refund to be received at any point in the next 5 days, weighted according to the given probability distribution. For a uniform probability distribution, the expected value (being the mean of the probability distribution) would be +2.5 days.

The stencil also defines one or more attributes for the modelled process. These are indicated in the attribute schedule functions 310a, 310b and 310c. For the “Apple Order” process, the attributes are “Apples”, indicating the number of apples received in the order, and two different cash attributes “Cash-1” and “Cash-2”, each indicating an amount of cash associated with the process. Attributes are key-value pairs and highly general.

Thus a process captures N+1 dimensions: the single dimension of time, and N pseudo-spatial dimensions, one per attribute. An attribute does not need to refer to some physical co-ordinate system (for example, an attribute may capture whether the received apples are red or green), and some attributes may themselves refer to time-based quantities (for example, the time a pie must remain in the oven to be cooked). In embodiments relating to monitoring business processes affecting inventory management, one or more of the attributes defined in the stencils may indicate an intended effect the process represented by the stencil has on a resource at completion of the process. In embodiments, the intended effect the process has on a resource indicated by the attributes may comprise one or more of: an availability of a resource; a physical location of a resource; a virtual location of a resource; a count of a resource; a status of a resource; a condition of a resource.

The process graph 304 sets out the progress of the process through a sequence of a predefined number of at least two discretized canonical states. The states are universal to each stencil for all modelled processes and the states in sequence represent indicators of increasing certainty about the progress of the processes (and their attribute values) from the initial state of the process to the final, done state of the process. That is, all processes modelled by stencils progress through a sequence of states (bearing in mind states may be skipped), as the outcome of the process is more settled.

Similarly, the attributes are expected to become more certain as the process evolves. While some may be determined at the moment of instantiation of the process (for example, a name, some classification, an asset, item, or resource that is being affected by the process), others become more definite (specifically known) at later points in the process (which may be when the process itself arrives at its done state, or before then). In this regard, the state of the attributes does not need to be synchronous with process state. Further, the attributes do not have to evolve through the states synchronously with each other, or with the process. Like the attributes, as the process evolves through the process graph 304 it also becomes more certain. The process schedule function 308 determines how the occurrence of events in the graph causes transitions in process state. Separately, the attribute schedule functions 310a, 310b and 310c determine how the outcome of events in graph cause transitions in the state of the corresponding attribute. That is, each attribute has a schedule function to map each node in the graph and path taken to a state. The same remarks and functionality apply as described for the schedule function of the process although an attribute may transition to done while there are other nodes remaining on a given path. The schedule functions thus imply when the process and attributes transition in state based on position in the graph.

Thus the stencil 230 includes a process schedule function 308 and a respective attribute schedule function 310a, 310b and 310c, for each attribute. Each schedule function specifies a mapping of states to events in the event-nodes 304n of the process graph 304 causing a transition of the respective attribute or process to a corresponding state. The states in sequence represent indicators of increasing certainty about the progress of the processes and their attribute values from the initial state of the process to the final, done state of the process.

Thus the process and attribute schedule functions interpret a position in the graph to one of the states of certainty. They consider events, which are specific to realities. As many processes do not have splits and so have no path-dependence, it is the events that change state, not reality splits.

Generally, for the process schedule function (not the attribute schedule functions):
When the process is initialized, it will start in the lowest state.
The done state must exist for a process; other states can be skipped.
The schedule function must be defined for every possible reality in which the process can terminate.
The process cannot go backwards in state.
Transitions must be causally possible and consistent with the information stream set out in the process graph. And while not reality-dependent per se, the transitions depend on the events defined in the realities.
A process cannot transition to done while there are outstanding nodes in the graph for that path or any paths outstanding.

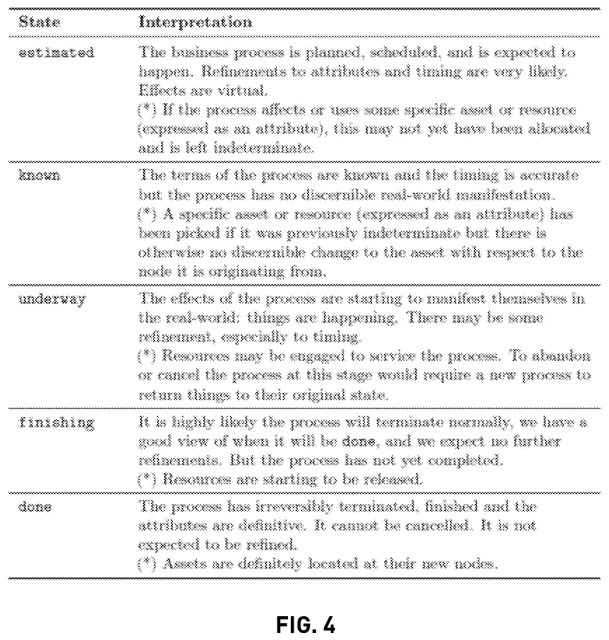

State is an indicator of how qualitatively certain we are concerning the progress of a process through its lifecycle and the attributes associated with it. As any process evolves, so it reaches higher states of certainty and the uncertainty of the values the attributes will take usually (but not necessarily) reduces. Conventional systems (if they can capture such uncertain data at all) may indicate such certainty with a status field specific to the type of process underway. There is an argument for state to take a continuous value, between 0 and 1, but this creates unnecessary complexity. By discretizing the certainty of the process into a handful of key canonical states that are universal and can apply to business data in general, this facilitates a common view of certainty across all processes, that can be queried. An example set of canonical states is set out in the table shown in FIG. 4, including a narrative interpretation of the certainty conditions in which that state should be applied to the process or attributes. We have chosen 5 states (excluding the special ‘vanished’ state, described below) as we believe, in the context of the interpretations given and the objective of the business management software system, that this represents a good trade-off between detail and universality. This is not a fixed parameter of the approach though: with two states the model becomes binary but bitemporality is still supported. However in any implementation of the business management software system disclosed herein, the number of states will be a fixed number. The states can be informally considered in 3 groups: while estimated and known, the process (or attribute) is effectively or mostly virtual and still being planned. There is little or no discernible real-world or manifest effect. We note that the known state corresponds to knowing the arguments determining the value of an attribute concretely, or knowing the main parameters determining the overall character of the process, so while estimated, the attributes may be subject to variation. But once known, all these are taken to be concrete. Once underway and finishing (which can be considered a checkpoint on progress), it is considered that the process has been committed to and that aborting at this point would incur cost (wasted materials, energy, disruption etc.). Variability in outcomes depends principally on execution. Attributes which are in the underway and finishing states do not typically have path-dependence and their value is relatively certain compared to earlier states. Sometimes the known and underway states will coincide. Once done it is considered that the process has completed and its effects and terms are definitive. For an attribute which is done its value is definitive, notwithstanding the possibility for late corrections and adjustments to it. These qualitative states allow a high-level and cross-system evaluation of the relative certainty of data and processes managed by the system.

There are 3 states which are readily applied to each attribute and the process, which can be considered ‘boundary conditions’:
estimated: the first state, corresponding to the first node in the graph.
done: the last state, corresponding to the node where the user defines that the attribute becomes fully certain. For the process, this corresponds to when the process has irreversibly terminated, finished and the attributes are definitive. It cannot be cancelled and it is not expected to be refined.
vanished when the path to the attribute has weight 0 and can no longer be accessed.

Each process graph 304 starts at root event-node at which the process is in a first, initial state (e.g. “estimated”) to one or more leaf event-nodes defining one or more terminal mutually exclusive possible realities in which the process is considered to be in a final, done state. Where path dependence is accommodated in a process graph, the minimal states an attribute can be assigned are off, on and vanished. The user may choose that an attribute or process start in a higher state than estimated at initialization, and also has freedom to determine where the attribute and process should transition to intermediate states, whether one of the 5 described or their own set.

The job of the user therefore is to specify in the schedule function, which intermediate nodes in the graph cause each attribute and the process to transition to the states between estimated (the lowest) and done (the highest).

The stencil 230 also includes a set of methods 306. For each event-node, the implementer of the process graph defines a method which is called when the process transitions to that event-node in the process graph. The name “method” has a similar interpretation to an object-oriented language's usage of the word. Methods provide a safe and controlled way for a process to be manipulated. They are implemented by the designer of the process stencil and constitute the user's domain model of the process. Methods are connected to receipt of information in relation to the event related to the transition to the corresponding event-node, as specified in the process graph.

Each of the methods 306 defines arguments corresponding to the information that is conveyed by the occurrence of the event (or which is relevant to the event node and is received or retrieved and is current at the time of the occurrence of the event—for example, a currently forecast temperature for a future date). For example, following receipt of an event corresponding to the “ordered” node in the process graph 304, the ordered(order_date, quantity_kg, price_per_kg) method is called. The ordered method thus takes the following arguments: order_date, quantity_kg, price_per_kg.

A method must be defined for every node in the graph as they are the means by which the current position in the graph moves forwards onto the next edge to wait for the following transition. As will be described below in relation to FIG. 12, in embodiments, the calling of a method for a given event-node may be what causes the process object instantiated to monitor a given process to generate and append a new database record (e.g. a block) for the process.

The methods 306 also implement the means by which the designer of the process graph 304 and stencil 230 forecasts and eventually sets the value of each attribute. By having different methods which can be assigned to different nodes, each method can implement different forecasting machinery at different points in the evolution of the process. For example, at initialization in the estimated state, only coarse-grained forecasting is possible. Once underway, more detailed information is available, enabling use of a more detailed algorithm. Finally, the method corresponding to an attribute's transition to the done state doesn't forecast at all but merely sets the value (which is possibly derived from the method's arguments). Thus the logic which forecasts or sets the value of the attributes is not merely a property of the stencil as a whole, which would effectively make such logic constant between transitions along the process to higher states of certainty. Instead, the logic which forecasts the value of an attribute (or a probability distribution for the attribute) is not (necessarily) constant throughout the lifecycle of the attribute.

Methods defined on the process are to be called when events occur or conditions arise, consistent with the process' position in its process graph, and their arguments impart additional information which may include:
the observed value of some attribute that is to transition to the final done state,
information that the method and embedded forecasting function can use to refine the knowledge of the process and knowledge and view of all and any attributes
   whether they are already in the final, done state (it is a correction) or
   are still subject to evolution,
   and regardless of whether they transition state.

When the method refining the value of an attribute (or more generally, any and all attributes) is evaluated it may generally return (and cause to be recorded in a new database record stored in the store of database records 234):
a single value for the attribute (required for the final, done state, but optionally for lesser states), (NB. the value has a vector form of uncertainty which collapses to a singular value, but the type of value itself may be a list, object, vector, image.)
and for an attribute still subject to uncertainty in a state lower than the final, done state, it may return
   a set of possible values, and optionally probabilities, or
   more generally a (probability) distribution, whether analytic (for example, a normal distribution with a given mean and standard deviation) or empirical (e.g. a histogram).

This new result returned from the method, when called for a newly arrived-at event-node, replaces the prevailing view of the attribute(s), and is stored in the new database record.

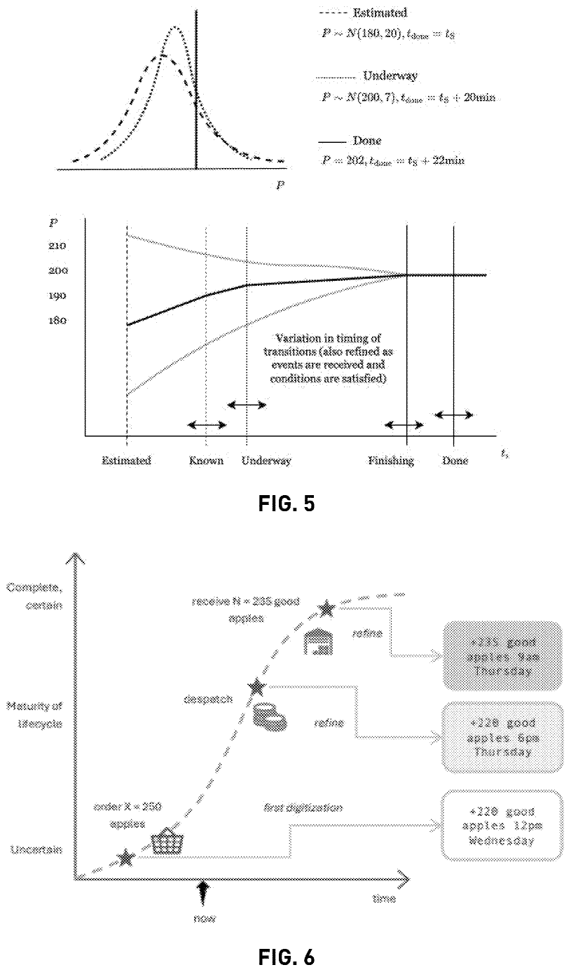

Note that state is a qualitative labelling of uncertainty. In embodiments, for attributes not yet in the done state, the attributes may be defined as probability distributions that forecast the probability the attribute will take its different possible values when the attribute reaches the done state in the process, the expected value for the attribute being determinable based on the distribution, wherein the methods may optionally include instructions that, on being called, produce the probability distribution for one or more of the attributes. FIG. 5 illustrates how a spatial attribute, initially specified by a distribution providing a quantitative assessment of uncertainty, eventually settles to a scalar (or, rather, singular) value as the process evolves, with a corresponding change in the qualitative state. That is, the methods specified for the attribute return probability distributions which narrow as the process matures and the attributes reach a state of higher certainty. For example, when in the estimated state at tₛ, the corresponding method returns a probability distribution having a normal distribution centered on a value of 180, and having a standard deviation of 20. When in the underway state at tₛ+20 min, the corresponding method returns a probability distribution having a normal distribution centered on a different, higher value of 200, and having a smaller standard deviation of 7, giving a narrower distribution of expected outcomes. The expected value for the attribute at each stage of the process is given, in this case, by the mean of the probability distribution (so, 180 when estimated, then 200 when underway). When the process reaches a later event-node at which the attribute arrives at the finishing state at tₛ+22 min, the corresponding method returns a single value for the attribute, which may be based on an observation of the attribute or arguments for the method, and the attribute value is definitive with further refinement not expected.

However, methods may also be defined or the methods may be called to refine or correct information relating to a process on an ad-hoc basis. Information can also be received to change some parameters, such as timing information on a time split. For example, while awaiting delivery of apples, we receive information that updates the times and probabilities of arrival. Refining methods allow a re-triggering of attribute estimation without an event in the graph, for example, a new weather forecast triggers re-estimation of apple quality.

Continuing the “Apples Order” process set out in process graph 304 (and ignoring path dependence for the time being), as shown in FIG. 6, for the attribute “number of [good] apples received”, the number of apples we will eventually receive in the warehouse evolves through a lifecycle. From the first moment, we can take a view of the eventual data, and gradually refine the values in space and time until they become settled facts.

Thus, in embodiments, the stencil for each modelled process may include, for each event-node in the process graph, instructions defining a method as a function executable to initialize or update the expected value for attributes of the process based on information received in messages corresponding to events matching that event-node, wherein the methods in a stencil together constitute the domain model defined for the process, wherein the instructions may be further configured to cause the process object, when an event may be received corresponding to a transition to an event-node in the process graph for the monitored process, to call the method defined for that event-node passing arguments to the method based at least in part data related to the received event, the calling of the method optionally causing the process object to generate and store the record in the database.

In embodiments, each stencil may include instructions specifying an initialize method provided as the root event-node in the process graph corresponding to an event mapped to the first state in the schedule function for the process, the process graph thereby causing the initialize method to be called on instantiation of a process object based on the stencil to initialize a forecast of the expected values for all the attributes of the process. Thus the special init( . . . ) method in methods 306 initializes a process from the stencil 230 and puts attributes and the process in the first state specified by their schedule functions, which is usually estimated. The initializer must provide a forecast (best estimate) expected value (V) for each of the attributes in the process. We typically think of attributes as numerical but they can well be non-numerical, in which case a best estimate is not possible: the attribute may simply be “indeterminate”.

The process must eventually finish in one of several realities. A reality is a mutually exclusive sequence of events in the graph where the business process behaves in a particular way. For any given execution of the process, the precise data may vary (number of good parts=7, or 9, or 12) but these are all “in the same reality” provided that the consequences are the same, e.g. the number of good parts is more than some critical value (e.g. 5).

More formally, all processes start in a single reality. This reality may split into distinct realities, and so on. Thus, in embodiments, the stencils 230 may be configured such that the process graph 304 for each process may be configurable to include one or more path splits occurring at (or rather, on the path following) one or more event-nodes 304n. This reflects that, in different process objects 232 instantiated to monitor different instances of the same process, events/data messages can be received that cause the process graph 304 of the process object to diverge by transitioning along different paths to distinct realities 304r (denoted as circles in the process graph 304 shown in FIG. 3) in a path-dependent manner from the root event-node (shown as the circle with index ‘0’ in FIG. 3) along edges through different event-nodes to one or more leaf event-nodes existing in different realities.

The process graph 304 is arranged as a directed root tree (DRT) (also called arborescences, out-trees or n-ary trees), encoding domain-specific prior knowledge about how the business process propagates from a root event-node to one or more leaf event-nodes. Directed root trees are a special class of Directed Acyclic Graphs (DAG), with unique paths from the singular root node to any other node. Each edge direction is oriented away from the root, ensuring a hierarchical relationship among the nodes. Thus the directed root tree represents a hierarchy with a designated root event-node from which all other event-nodes nodes are reachable through directed edges along which allow transitions in one direction, away from the root, only. The directed nature of the edges implies a clear parent-child relationship in one direction, from parent to child. These capture the possible cause and effect relationships of events to the possible conclusion of the process. That is, the edges indicate the possibility of progression from one event-node to the next. In a directed root tree structure, each event-node, except the root, has exactly one incoming edge, ensuring a unique path from the root to any other event-node in the tree. However, in a directed root tree, event-nodes may have more than one outgoing edge (or rather, a single outgoing edge that splits to two or more different possible subsequent event nodes in possibly more than a single reality). This indicates that possible paths through the directed root tree from the root event-node can arrive at more than one possible leaf. However, as a DRT, the process graph is constructed such that there is a unique path through the process graph of event-nodes and edges to any event-node.

A path thus denotes the sequence of nodes and edges that are traversed in the reality graph. Because the process graph 304 is a DRT, and not a DAG, there is a unique path to any node in the graph. While specifying the location in the graph simply by the event-node is therefore all that is needed to know the path to the event-node, it is more useful to specify the full path when referring to a reality. For example, instead of “R(2)”, we can write “R(0,2)”.

In the Apples Order process graph 304 shown in FIG. 3, the process is modelled such that it can end in three different, mutually exclusive realities. The first, shown as the circle with index ‘1’ in FIG. 3, is the reality in which the order is abandoned instead of being confirmed. The second, shown as the circle with index ‘3’ in FIG. 3, is the reality in which the order is cancelled and refunded instead of being delivered. The third, shown as the circle with index ‘4’ in FIG. 3, is the reality in which the order is confirmed and delivered. The intermediate reality, shown as the circle with index ‘2’ in FIG. 3, is the reality in which the order has been confirmed (and paid for), but it has not yet been delivered or cancelled and refunded.

The terminal realities in the process graph 304 shown in FIG. 3 are traversed by the following three paths:
R(0,1)
R(0,2,3)
R(0,2,4)

Labelling the possible realities this way tells us at which points they diverge. Realities have a stream of information in common up to and including the indices that they have in common. For example, up to index label 2, realities R(0,2,3) and R(0,2,4) have exactly the same events and timings. The time intervals specified between events in the process graph is the same for all realities up to the point they diverge.

Thus, in embodiments, the distinct realities in a process graph may be indexed by a sequence of identifiers of the event-nodes in the path to that terminal event-node, the sequence of identifiers including at least those event-nodes at which path splits occurred. For example, the reality in which the Apples Order is cancelled and refunded may be indexed as R(0,2,3). The reality in which the Apples Order is successfully delivered may be indexed as R(0,2,4). The process object may generate and store in each database record a record of the reality history for the monitored process. This may include the indexed sequence of identifiers to the current event-node.

The graph of reality splits is itself a directed root tree. When drawing a process graph 304 as shown in FIG. 3, the realities may be included, drawn as circles, but they aren't nodes in the process graph like the event-nodes we have described. Rather, they are annotations. The reality graphs could be drawn separately but to ensure consistency and aid clarity the process graph is drawn with realities included. Each reality is given a unique identifier (e.g. here we simply use a positive integer unique to each graph). Each process graph can therefore be looked at in two ways: in terms of an event timeline or as realities.

Realities only change when there is a possibility to do so. However, retrospectively, (a) we exist in a single reality, and (b) the graph of realities is a single path with weights of 1 on each edge. So realities only change when path-dependence is involved. If there's no path dependence, there is no splitting. A large number of simple processes start and forever remain in the single reality of R(0).

In embodiments, the process graph may be configured such that, within a reality the value of some variable, prevailing value of an attribute, of event data received for different instances of the process may fall within a range of tolerable possible values provided the causal consequences within the process may be deemed immaterial and lead to compatible and consistent outcomes within that reality, and between different realities the data received for the process may be such that the causal consequences within the process may be deemed materially different leading to mutually exclusive outcomes between the different realities.

Directed root trees thus provide a powerful and flexible framework to model complex business workflows and decision-making sequences. This representation is inherently hierarchical, allowing for the nesting of processes in a tree-like fashion. The true path taken through this process graph 304 is determined by the external information passed to the system (e.g. as observed events that trigger the transitions), enabling dynamic and context-sensitive execution of a process. By leveraging DRTs, the system can efficiently manage dependencies, ensure that each steps in the process are executed in the correct order, and handle parallel or conditional branches with ease. This approach not only simplifies the visualization and management of complex processes but also enhances the system's ability to adapt to varying inputs and evolving conditions, providing a robust solution for modeling and executing intricate business workflows.

Each edge 304e is thus assigned a weight indicated in FIG. 3 by the value ‘w’ associated with the edges. This weight indicates the expected probability of monitored instances of the process transitioning from one event to another along a path to a given reality. Within a progress graph in which there is no splitting, the possibility is always 1 (i.e. the weight or probability applied to the outgoing edge), notwithstanding the possibility of an unexpected event leading to the process being quarantined. At a branching with multiple edges branching to different realities, each outgoing edge after the split has a possibility within [0, 1] (i.e. less than 1 and more than 0, save for providing for the possibility of rare and unusual events with zero a priori probability occurring, which may be provided for arising from any node, even alongside edges having a weight of 1 at which no reality split ostensibly occurs). The weights are crucial for deriving the corresponding probabilities of traversing each path. These weights reflect the likelihood of transitioning from one step to another within the process. As will be explained below, these weights can be dynamically updated, for example, for a query at a given information time, based on the arrival of new information or the passage of time. This continuous updating mechanism ensures that the system remains adaptive and responsive to changes in the external environment.

Possible realities can be made known to the process either:
With a known or estimated a-priori probability—In this case the possible paths and realities are drawn and probabilities are associated with each splitting event.
With a zero a-priori probability—As before, but some realities may be so rare or unusual that, while it's useful to capture the possibility of their occurrence, to all intents and purposes their probability cannot be reliably estimated. In this case associating a zero probability to them is more of a statement of “This never happens, apart from when it does . . . ”. From a scientific perspective this sounds strange, but from a practical perspective many business users would appreciate not being cluttered with rare realities, but the system of data must be ready to handle such a thing, if it should arise. Some information may arise that the probability of this reality changes from 0 to non-zero. Such a feature can also be useful to reduce the number of realities to be explored.
On an ad-hoc basis, via a systematically available “escape” or exception mechanism whereby an alternative reality arrives ‘by surprise’ and the system must react to cater for it.

The lifecycle of an event may include path dependence, and consequently the business data that ultimately manifests may vary not just spatially (value) and temporally (timing), but in its existence. Consider again the process graph 304 for the Apples Order process shown in FIG. 3: this shows the possibility that the order is cancelled (denoted by the path of realities R(0, 2, 3), perhaps on such a cancellation we simply receive a refund. In this case, there are no apples.

The process and its data are thus materially different in different realities: in the case of ordering apples, provided the order is not cancelled, then whether the apples eventually arrive after 4 days or 7 days is immaterial and the outcome is in the same reality. However, if the order is cancelled, then the situation is a different reality. Thus, in embodiments, the process graph 304 for a process should be constructed such that, within a reality the value of some variable, prevailing value of an attribute, of event data received for different instances of the process may fall within a range of tolerable possible values provided the causal consequences within the process may be deemed immaterial and lead to compatible and consistent outcomes within that reality, and between different realities the data received for the process may be such that the causal consequences within the process may be deemed materially different leading to mutually exclusive outcomes between the different realities.

Realities are local to a process: the consequences of apples arriving after 7 days rather than 4 may invoke different realities external to the process. Thus, in embodiments, the possible realities for a given process may be local to the process, and the attribute values for the process within the possible realities may affect other, external processes.

In embodiments, the process graph and attribute schedule functions may be configured such that each attribute “belongs” to a single reality such that, for that reality and realities stemming from all paths following from that reality, the attribute exists, and for processes that take a path that does not encompass the reality to which an attribute belongs, the existence of that attribute may be deemed incompatible with those other realities, and the schedule function maps the attribute to a vanished state. In this sense, an attribute can be said to “belong” to a single reality. That is the reality in which it is no longer possible for the attribute to vanish. For example, if an attribute belongs to R(0, 5, 17, 24), then on any other path with labels differing up to the 4th index, the attribute will vanish. For example, on R(0, 5, 18, . . . ) the attribute vanishes, but not on R(0, 5, 17, 24, 39) because realities subsequent to R(24) have no bearing on the attribute's existence. The attribute does not necessarily transition to done as soon as the reality to which it ‘belongs’ is reached: there may be subsequent events in the reality to transition it into “done” but all those events must occur before any further splitting of realities.

The schedule function for an attribute does not need to explicitly specify transitions to the vanished state: if the process transitions to any reality incompatible with the eventual existence of the attribute, then it has implicitly vanished.

In embodiments, the process graph may be configured such that, at an event-node from which the process splits and proceeds along one or more different edges on different paths to distinct realities, the path along which an instance of the process proceeds may be conditional on one or more criteria of the group including:
a time at which the event may be received or by which the event may be not received,
a value of some variable or attribute for the process prevailing at the time of receipt or non-receipt of the event,
which of a set of mutually exclusive possible events may be received.

The software modules 220 may be further configured to cause the process object 232, when the monitored process is at an event-node from which the process subsequently splits to different realities, to selectively transition along the available paths based on the criteria for that event-node to the corresponding subsequent event-node in the process graph.

The path taken through the graph may thus depend on time, space, or which of a set of possible events is received next. Such a decision causes the incoming reality to split into two or more descendant realities. Thus a reality splits into multiple ‘sub realities’ as the path splits and tree branches.

Possible paths into distinct realities are conditionally followed based on 3 kinds of splitting at a node: by time, by space, by mutually exclusive events or some combination of the three.

For a path split into distinct realities by time, the timeline for receipt of information or occurrence of an event is divided into intervals, and the process evolves along distinct paths into distinct realities depending on which of the interval the information arrives or event occurs. For example, we are waiting on shipment arrival, and there are different consequences depending on whether the shipment arrives within time or critically late. It is important to note that we know the shipment is going to be late as soon as it has no longer arrived within time. We do not need to wait for the late shipment to arrive to know that it's going to be late, and we can invoke actions at the moment of realization of this knowledge.

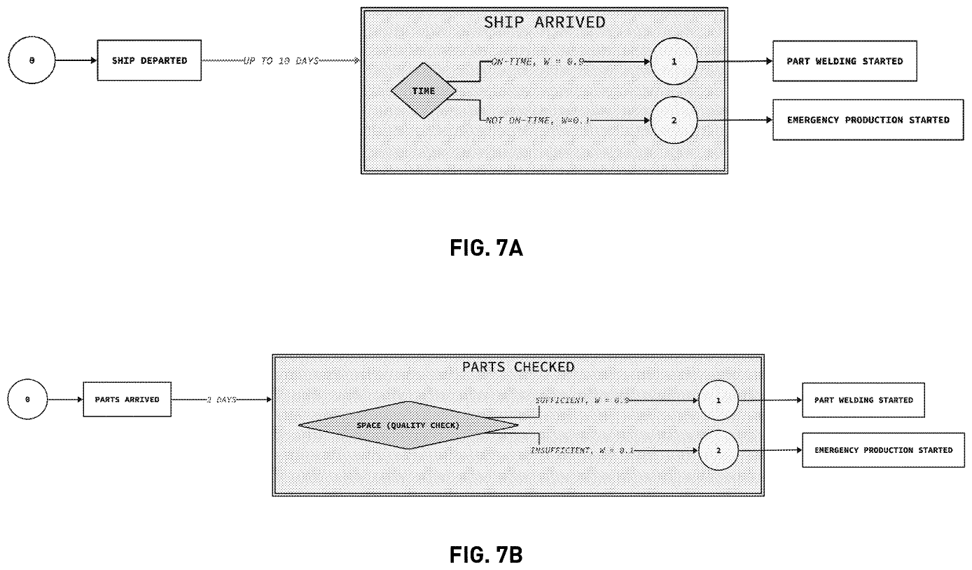

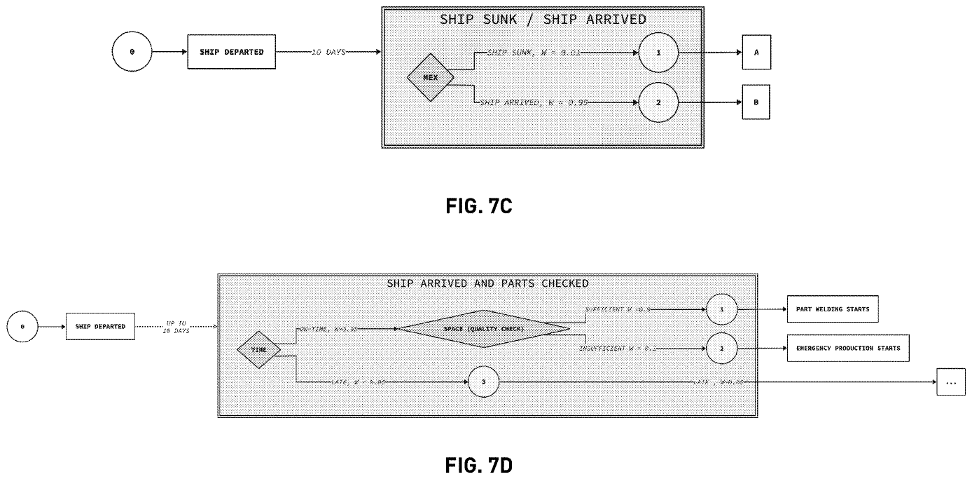

An example process graph including a time split is shown in FIG. 7A in which the time interval in which the event arrives determines which subsequent path is taken. The terminal realities here are:
R(0,1) parts arrived on time, and welding began
R(0,2) the ship has not arrived on time and emergency production is started at the point that it is known to be late.

In the example above, a uniform distribution of arrival time is split into two intervals. More complex timing distributions can be approximated with a sequence of piecewise uniform distributions, each with different weights and widths. Information can be received by the process causing it to refine its estimate of the timing distribution.

For a path split into different realities by space (i.e. a pseudo-spatial value), different paths are taken depending in which interval some attribute falls. For example, whether a sufficient number of good apples are received, or insufficient, or whether the apples are red or green. That is, depending on the value of some attribute, argument, data, or property prevailing what we generally refer to as a spatial value—the graph may evolve differently. Such a spatial value can result from executing a bitemporal query of another process or the system at large. (In this context, a duration, date or time can be treated as a spatial attribute, but it's not the same thing as a time splitting.)

An example process graph including a time split is shown in FIG. 7B, in which the value of an attribute or other variable determines which subsequent path is taken. The terminal realities are:
R(0,1): there were sufficient parts, so welding began.
R(0,2): there were insufficient parts, so emergency production was started.

For a path split into different realities by mutually exclusive events, while splitting on time or space references the same event, branching can occur due to which event from a set of mutually exclusive events occurs. For example, ‘shipment arrived’ will never happen because ‘ship sunk’ occurred instead. A mutually exclusive event is just a space split in disguise where the alternatives are mutually exclusive.

An example process graph including a mutually exclusive or ‘mex’ split is shown in FIG. 7C, in which the path or paths to be followed are determined depending on whether event A or event B is received. In the example, an event arrives, the question is whether its label is “ship sunk” or “ship arrived”. The terminal realities are:
R(0,1): this ship sank
R(0,2): this ship arrived

Additionally, splits of different kinds (time, space, mex) can be combined without intermediate nodes or realities. An example process graph including a combination split is shown in FIG. 7D, in which, if the shipment arrives on time, the parts are immediately checked for quality. Here, the terminal realities are:
R(0,1): on time arrival of good parts
R(0,2): on time arrival but parts were bad
R(0,3): parts arrived late

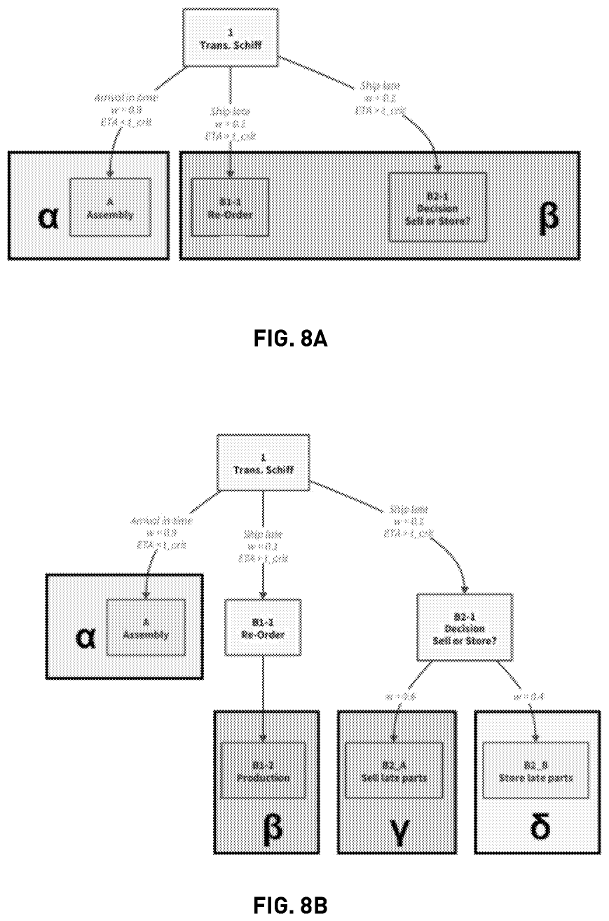

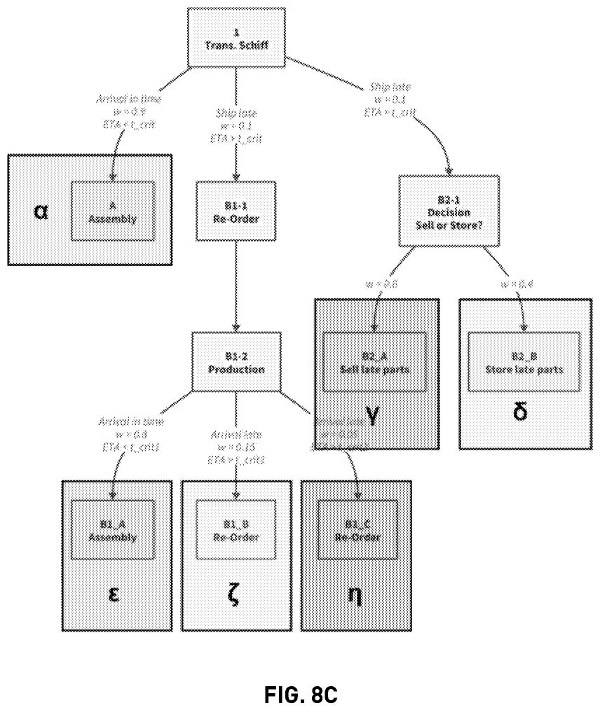

Following any such splitting there may be multiple, parallel-executing paths or there may be mutually exclusive paths (do not confuse with mutually exclusive events). An example is shown in FIG. 8A, FIG. 8B and FIG. 8C. The paths are grouped based on their compatibility with a distinct reality emerging for each group of paths. Hence it can now be appreciated that a path and a reality are not one to one as a reality may contain multiple paths executing in parallel. To calculate expectation values across the DRT, all reality combinations have to be explored.

Let us introduce the reality operators, which are similar to boolean algebra:

α|β: reality α or reality β can occur.

α∧β: reality α and reality β will occur in parallel.

α∧(β|γ)=(α∧β)|(α∧γ): distributive property “dyadic reality product”, reality α will occur together with reality β or reality γ.

FIG. 8A, FIG. 8B and FIG. 8C show the progression of branching of realities in same process graph.
(a) In FIG. 8A, a temporal split occurs: the arrival time of an event determines which of the two exclusive realities (α or β) will manifest. In reality β, there are two parallel branches, B₁ and B₂.
(b) Then, in FIG. 8B, reality β splits into two exclusive realities, γ and δ. The possible combined realities are now α|(β, γ)|(β, δ). In slightly different notation: {α|β∧(γ|δ)}.
(c) Then, in FIG. 8C, reality splits into three exclusive realities ϵ, ζ, and η. The possible combined realities are thus {α|(ϵ|ζ|η)\hat{ }(γ|δ)}.

In FIG. 8C, if the process (and attributes) are in a done state in each reality, we thus obtain the following distinct terminal realities: α, γ, δ, ϵ, ζ, η. The possible combinations of those realities are

$$α \vert ( ( ϵ \vert ζ \vert η ) ∧ ( γ \vert δ ) ) = α \vert ( ϵ ∧ γ ) \vert ( ϵ ∧ δ ) \vert ( ζ ∧ γ ) \vert ( ζ ∧ δ ) \vert ( η ∧ γ ) \vert ( η ∧ δ )$$

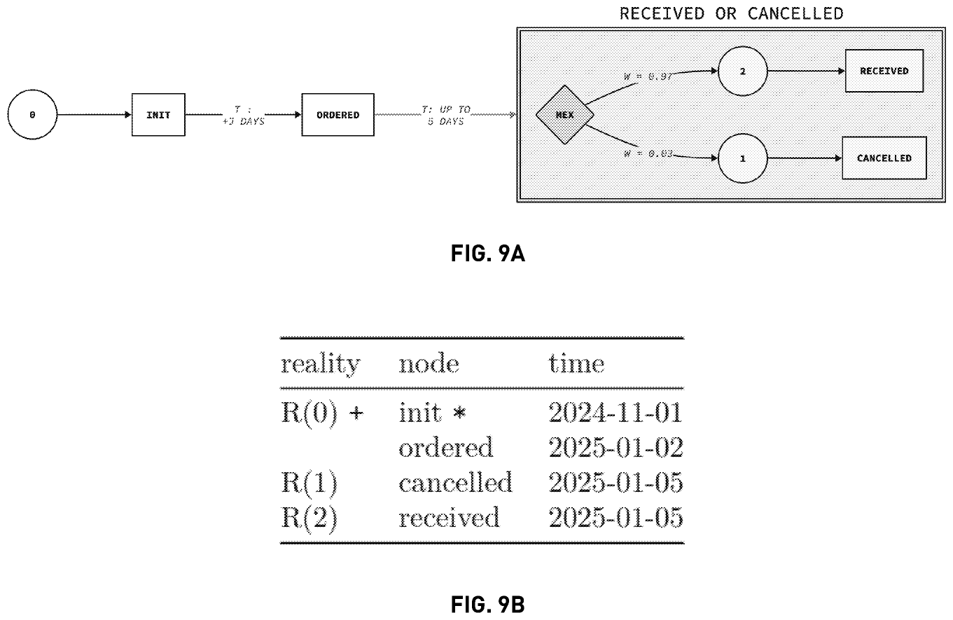

A further example process graph is shown in FIG. 9A where some item is expected to be ordered at a fixed date on initialization (init), then ordered, then either received with 97% probability or cancelled with 3% probability up to 5 days later. Let us assume that today is 2024-11-01, and we envisage ordering this item on 2025-01-02. We are in reality R(0). The value of J is +62 days. Consider the floating time interval between ordering and either receipt or cancellation, of “up to 5 days”. Assuming the probability distribution is uniform, the expectation value of this is 2.5 days. Rounding up, the expectation date is 2025-01-05. Given what we know at 2024-11-01, the realities, events, and their expectation times are shown in FIG. 9B, where + annotates that the reality is the present reality, and * annotates a reality or node (event) as being historic. These timings won't change (unless we receive new, modifying information) until 2024-01-02 because the interval we are in is fixed. To find out which events belong to the reality R(2), one must simply traverse the path R(0,2) and obtain “init”, “ordered”, and “received”.

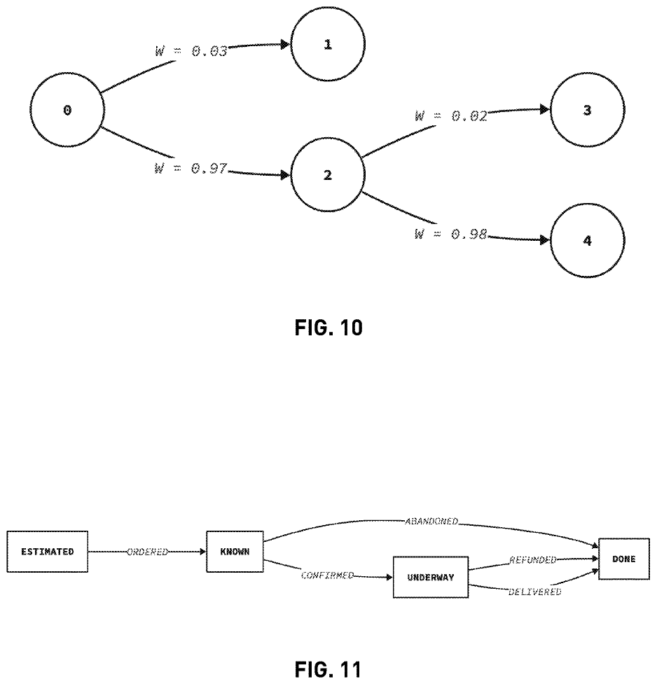

As can be seen in FIG. 10, the tree of realities navigable for a process as set out in the process graph 304 can also be arranged or viewed as a directed root tree, in which the realities represent nodes, and the edges represent reality splits indicated by their relative weights. Here, the tree of realities for the ‘Apple Order’ process is shown, and note it makes no reference to the underlying event-nodes in the process graph 304.

Attributes and processes cannot go backwards, and nor can time. However, these can be handled in a forward-looking manner by use of different realities while the schedule function interprets each reality differently.

The schedule function (for the process and for the attributes) can be expressed in state machine form (but as a directed acyclic graph, not a directed root tree) where the nodes correspond to the states, and the edges correspond to event-nodes in the process graph. For example, the schedule function for the process state of the ‘Apples Order’ process is shown in state machine form in FIG. 11, in which the ‘done’ process state node can be reached from multiple ‘event’ edges including from the ‘known’ process state node through a process ‘abandoned’ event, and from the ‘underway’ process state node through a process ‘refunded’ event or through a process ‘delivered’ event.

In the Apple Order process shown in the process graph 304 in FIG. 3 case, there are two distinct attributes (cash-1, cash-2) which arise in distinct (and mutually exclusive) realities. As shown in the attribute schedule function 310b, cash-1 representing a cash payment for the order of apples is “done” in reality R(0, 2), representing that the money has been paid. However, if the order is subsequently cancelled and a refund is given, cash-1 does not go ‘backwards’. Instead, a further attribute, cash-2, representing the refund, is used. According to the attribute schedule function 310c, cash-2 is initialized at the root node in reality R(0), but does not become underway until reality R(0, 2, 3) in which the order is cancelled, and only becomes “done” when the refund is completed later in reality R(0, 2, 3). Thus cash-2, the refund, cancels cash-1, the payment for the order. They are different transactions so this makes sense that they are different attributes and have different schedule functions. Cash-1 (the payment) does not vanish when cash-2 (the refund) is underway and done. Rather, in reality R(0, 2, 3) both cash-1 and cash-2 are “done” and (should) cancel each other out. However, in reality R(0, 2, 4), where the apples are delivered, this is mutually exclusive with a refund being given (a complaint or return would be a separate process), and so cash-2 is implicitly “vanished”, while cash-1 is “done”. That is, in the case of a refund, the original cash payment (attribute cash-1) remains. The refund (attribute cash-2) reverses the impact on cash but it does not delete or otherwise adjust the originally paid cash. Payment followed by a refund is not the same thing as neither never having happened.

Once instantiated, a process always exists; it can never vanish. However if a process takes a path where the attribute will not appear, then the attribute transitions to the vanished state. That is, at the conclusion of the process in a given terminal reality, all attributes in that reality must be in the done state, and all attributes outside the reality must be in the vanished state as they did not happen. Once an attribute is done, it can't be vanished unless there was some mistake in the data.

In embodiments, the schedule functions for the process and each attribute construct the progress through the process as a state machine constructed as a directed acyclic graph, and having the states as nodes and the events representing the mapped event-nodes in the schedule functions as the edges, wherein the schedule function may be such that the state cannot go backwards in the state machine towards the root of the directed acyclic graph. The schedule function can be expressed in state machine form (but as a DAG, not a DRT) where the edges correspond to nodes in the graph.

In embodiments, the process graph may be configured to split at an event-node to transition along multiple paths that execute in parallel, wherein the paths of parallel execution may be at least initially in the same reality. That is, a process can split into multiple paths of parallel execution. This is shown in the example of time splitting where once it is known that the ship will not arrive on time (FIG. 7A), emergency production of parts is initiated, while waiting on the late arrival of parts to be stored. These paths start in the same reality, but they may further individually split. This doesn't have to be on a reality split. (A process that is not path-dependent can spawn parallel running realities.)

This approach avoids getting into the complex and potentially fractal and recursive structure of concurrent paths by keeping processes in a single-threaded mindset. The parent process can spawn child processes. The parent process stays in a single thread of execution, in the same reality in which it spawned the child processes. Child processes are not brought into existence at the point of spawning: they already existed, and their attributes and such are already visible, but within the context of the parent process. The parent process waits for the child processes to return. Each child process may have complex internal structure of its own (splitting into many realities with different timescales). The parent process does not need to know about the structure: First, it can split after the child processes complete based on the outcomes of the child processes (e.g. what realities they individually and in combination arrive at). Second, because the time at which each child process completes is individually well-defined and calculable (with a weight for each final reality), the parent process can therefore compute the expectation times for the child processes to complete. Alternatively the user could specify the time intervals for the children to return separately. This is analogous to a manager (the parent) delegating work to subordinates: The manager stays single-threaded, and may decide to move forwards without waiting on the reports from subordinates. It's also closer to real-world approaches. The concept of “up to 5 days” is because we don't know the exact internal structure of what causes the event to happen when it does, so we put a probability distribution around it. Because child processes have the same path up to the point of spawning, any attributes within them can have schedule functions which refer to events in the parent process. Child processes could also emit messages (information, call methods) to the parent process that would allow the parent to refine its estimate of when the child processes will terminate. The advantage of this approach is:
no need for multithreaded schedule functions;
no need to figure out the weights and probabilities concerning the outer product of the realities arising from child parallel paths.

For example, running a pharmaceutical drug research project might involve running three experiments in parallel. Management will commit and allocate resources and time limits to each experiment, each one modelled as a process (a, b, c). If any experiment fails, the project is cancelled. If experiments do not complete in time the project is cancelled. If all complete successfully within time the project continues.

The process graph 304 thus describes:
the causal sequence of information that may be conveyed to the process;
the conditions for realities to split;
the timing of events.

It can be considered as the vertical-domain specific, prior knowledge of the information stream as it affects the process. This graph allows the process to not only serve possible future information that is path-dependent, but also allows the process to evolve, or propagate forwards conditionally through time and space. The agent that makes this happen (creating database records etc) can be the process object 232 itself as a semi-autonomous business entity (like a smart contract) or the database engine which interprets the data structures of the process (same result, different mechanism).

The process graph 304 is thus the data structure that allows the business management software system to propagate the data regarding the state of the business processes captured in the database forwards through time and space. The problem being solved is that, conventionally, a database cannot do this, because it doesn't know or understand how data behaves. It is for the application to make that happen. The computing apparatus 200 of the present disclosure allows the database to do this.

The combination of state and bitemporality allows the system to digitize uncertain, possible, future data alongside certain present and past factual data. Adding in path-dependence allows complex real-world processes to be digitized.

A stencil is thus an explicit expression of prior knowledge specific to the vertical domain of how an event evolves, capturing the logical relationships between causes and possible effects which manifest as business data. This knowledge can be exploited to inform views of the future. By introducing data structures that can cope with the lifecycle of events and their effects, so the data pertaining to business state becomes a dynamical construct, with the conditions for existence and certainty of each event's effect on business data obvious and explicit at every point.

Specification of a process in a stencil requires the initial values (which may be null or indeterminate) or distributions of the attributes and initial timings at which we expect the criteria to be satisfied. Where multiple paths are possible, the initial probabilities for these paths are also specified. These initial values, timings, and probabilities can specified based on policy, or empirically, and they can be updated over time. For the present discussion it is sufficient to recognize that while the initial values of attributes and timings may be highly uncertain, our view will become more definitive as the process evolves, eventually becoming settled matters at which point the attributes and effect on business state is definitive. Attributes which were specified as distributions eventually settle on scalar values. The probabilities or weights of various paths will also evolve and eventually become 1 (happened) or 0 (did not happen).

Turning now to FIG. 12, which shows a flow chart representative of an example business process monitoring and storage method 1200 in accordance with aspects of the present disclosure.

In embodiments, the business process monitoring and storage method 1200 is carried out by the process object manager 222 implemented based on instructions stored in software modules 220 in memory 204.

As noted above, the process object manager 222 refers to the library of stencils 230 also stored in memory 204, each of which defines one of a plurality of business processes in terms of its attributes and mapping the events that progress the process from initialization to completion along a process graph from a lower to a higher state of certainty arriving at one of set of possible terminal realities.

The business process monitoring and storage method 1200 starts in step 1202, in which the process object manager 222 monitors events received as messages in a stream or queue, for example, from User Terminal 212, Enterprise Event streaming Server 208, Enterprise systems servers 210 and/or External systems servers 216.

In decision step 1204, the process object manager 222 checks to see if any event is received matching an event-node in the process graph of a stencil for a monitored business process. If no such event is received, the business process monitoring and storage method 1200 loops back around to step 1202 to monitor incoming events and to continually check, through decision step 1204, whether they match an event-node in the process graph of a stencil for a monitored business process.

In decision step 1204, for any event that does match an event-node in the process graph of a stencil for a given business process, the process object manager 222 triggers the ensuing steps of the business process monitoring and storage method 1200 in relation to a process object for that given business process, and returns to looping back around to step 1202 to monitor received events.

Thus, in response to receipt of any event matching an event-node in the process graph of a stencil for a given business process, the business process monitoring and storage method 1200 proceeds. In optional decision step 1206 (as indicated by the dotted outline), the process object manager 222 may check memory 204 to see whether a process object 232 has already been instantiated for that specific instance of the monitored business process.

If no such process object 232 has already been instantiated, the business process monitoring and storage method 1200 proceeds to step 1208, whereby the process object manager 222 instantiates a new process object 232 to monitor the specific instance of the given business process. As noted, the process object 232 is instantiated from the stencil 230 defined for the corresponding process. As the process objects 232 are instantiated in memory 204 based on the stencils 230, which are program-code templates, the process objects 232 may persist in memory only as long as the time from when the process object is instantiated (e.g. on the initialization of the process) and until the process object is closed (e.g. on completion or abandonment of the process).

Once it is confirmed that a process object 232 exists for the monitored business process for which the received event provides an update as it corresponds to an event-node 304n in the process graph 304, the business process monitoring and storage method 1200 continues from either decision step 1206 or step 1208 to step 1210 in which the process object manager 222 instructs the process object 232 instantiated for the process based on the stencil for that process to transition to the corresponding event-node 304n in the process graph 304. Where the process object 232 is first initialised, it may be instructed to transition to the root event-node in the process graph 304, which serves to set initial states for the process and attributes and values or probability distributions for the attributes. This may be based at least in part on information contained in the message triggering the transition.

When the process object 232 receives an event and transitions to the corresponding event-node in the process graph, it also, in step 1212, is caused to generate a database record for the monitored process. As will be explained in more detail below, the generated database record contains an updated view of the current state of the process and its attributes at the information time the event was received, as well as the current view of how the process and its attributes are expected to evolve in future, capturing time, uncertainty and path dependence.

The step 1210 and/or the step 1212 may be effected by the process object manager 222 and/or the process object 232. The step 1210 and/or the step 1212 may be effected by calling the method defined for the event-node corresponding to the received event. The calling of the method may be performed by the process object manager 222 and/or the process object 232 itself. The calling of the method defined for the event-node may update the expected value (or probability distribution) for attributes of the process based on information received in messages corresponding to events matching that event-node, and/or on other information, such as external information relating to the environment, or through calls or queries to other process objects or database records 234.

Then, in step 1214, the generated database record is stored in the store of database records 234. This may be a persistent store. A mechanism may be provided for the indexing and retrieval of the database record from the store of database records 234.

Following the storing of the generated database record, the business process monitoring and storage method 1200 returns to step 1202 and continues monitoring for events including further events that progress the monitored process. When such a further event is received, the business process monitoring and storage method 1200 proceeds again through step 1206, step 1210, step 1212 and step 1214 to update the process object 232 with updated information to form an updated view of the current state of the process and its attributes at the information time the new event was received, as well as the updated view of how the process and its attributes are expected to evolve in future, capturing time, uncertainty and path dependence. Generally, later updates will typically (but not necessarily) reduce uncertainty in the outcome of the process and transform the process and/or attributes to a higher/later state in the sequence.

The business process monitoring and storage method 1200 continues, for a given monitored business process, and process object 232, to loop around the flow diagram every time a new event is received for the process, updating the process object 232, and generating and storing an updated view of the current state of the process and its expected future evolution, until the process arrives at its final, done state, in which the outcome of the process is certain, it is manifest in a single, terminal reality, and in which the effects of the process on attributes (representing e.g. resources or assets) are definitively known and have settled values, in their final, done states.

Where process objects 232, are configured to be aware of other processes and respond to them in an automated manner, the process object may query other process objects 232 or other external data for themselves. For instance, a process object that monitors a process that causes all fruit of a certain batch to rot will transition (to known or later state) when the expiry time is reached, but it may measure the fruit that matches the criterion for expiry. A process can be capable of doing this itself rather than depend on a centralized model. A process object could also inspect market data to obtain a price or a rate, or other external data. The output functions and schedule functions of process objects allow for such a capability. By moving past the idea that process objects are essentially passive isolated data structures, a much richer range of functionality is possible, offering greater resilience, scalability, and less effort in building a centralized ‘command-and-control’ model.

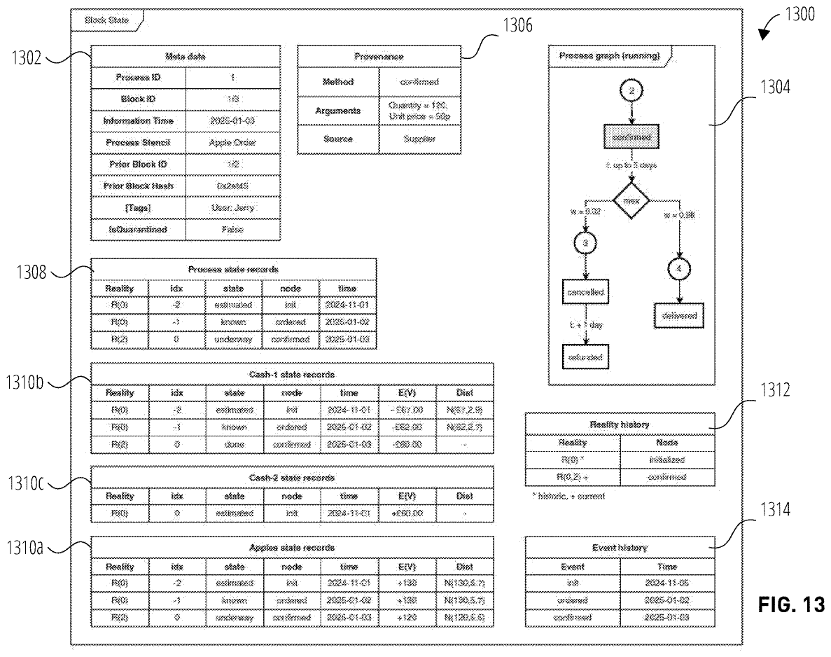

An example database record 1300 generated and stored by the process object manager 222 as a result of the business process monitoring and storage method 1200 will now be described with reference to FIG. 13.

As will be explained, the database record 1300 captures the present, and future view of the process's evolution in terms of its currently expected values for the attributes and a view of the possible future evolution of the process to the still-available terminal realities. The database record may also capture a view of the past evolution of the process to its current position in the process graph. These views can thus be obtained from a single database record alone, without referring to any other database records.

In the example, the database record 1300 is generated by the business process monitoring and storage method 1200 as a block. A block is an immutable denormalized entity capturing a complete view of the state of the process at the point in information time that the block was created, which may correspond to the time of receipt of the event causing the block generation, and thus the time that the process has been deemed to transition to the current effect state. As will be explained below, where generated as a block, the process object may generate, over time as the process progresses, an append-only backwards linked list of denormalized, complete, immutable blocks forming a contiguous span through information time.

The database record 1300 includes at least a residual process graph 1304 and state records for the process and each attribute. The example database record 1300 shown in FIG. 13 is generated for the Apples Order process. It includes a process state record 1308 and attribute state record 1310b for the ‘Cash-1’ attribute, attribute state record 1310c for the ‘Cash-2’ attribute and attribute state record 1310a for the ‘Apples’ attribute.

In the example, the database record 1300 also includes meta data 1302, provenance 1306, reality history 1312 and event history 1314.

The meta data 1302 includes various fields used to identify the database record 1300 in the context of the process and its progress. For example, the ‘Process Stencil’ indicates that the process object 232 that generated the database record 1300 was instantiated based on the ‘Apple Order’ process stencil stored in the library of stencils 230. The ‘Process ID’ field indicates that the database record 1300 belongs to a specific instance of the process being monitored by a specific process object 232 instantiated to monitor a specific order for apples, to distinguish it from database records that have been generated by process objects monitoring different apples orders. The information time at which the database record 1300 was created (or at which the event was received, which in the example are taken to be the same) is included in the ‘Information Time’ field with the necessary granularity. The ‘[Tags]’ field allows other useful key-value information to be associated with the database record 1300 such as the name of the user or system who created the database record 1300 or corresponding process object 232 etc. If the information content of the database record 1300 is suspect, or implies an anomalous condition, the database record 1300 may be marked as quarantined using the ‘isQuarantined’ boolean field. When a process is reviewed by an operator or otherwise released from quarantine a new database record 1300 may be generated with the quarantine condition removed.

The provenance 1306 includes fields that describe the instruction that was sent to the process object 232 that caused this database record 1300 to be created and other contextual information. For example, the provenance 1306 indicates in a ‘Method’ field that the database record 1300 was generated by the process object 232 receiving an event (from the supplier, as indicated in the ‘Source’ field) that caused the ‘confirmed’ method of the process object 232 (as defined by the Apples Order stencil) to be called, indicating that the order for the applies has been confirmed with the supplier. The arguments passed to the ‘confirmed’ method, as updated by data included in the received event message, are recorded in the ‘Arguments’ field, indicating that the confirmed order includes 120 apples at a unit price of 50 pence.

Methods called out of causal sequence with respect to the process graph 304 (e.g. calling ‘init’ after ‘ordered’) will fail. This can cause the process to transition into the quarantined condition. The graph expresses the prior domain knowledge of how the process should evolve, but the real world has a habit of throwing surprises. A process designed to exclusively manage ordering and receipt of apples may be troubled when a banana arrives too. This could reasonably cause the process to reject the incoming information and fail (become quarantined). The process can no longer evolve according to the process graph. A method can be defined to ensure that the process can be “re-railed” and/or subsequently evolved manually if need be. A method can be defined to release a process from the quarantined condition. Thus the process object manager 222 may selectively cause the process object 232 to transition the process to a quarantined state when an event is be received in relation to the monitored process that is out of sequence in the process graph, when an event is received in relation to the monitored process that may be incompatible with the current reality and any remaining possible realities modelled for the process in the process graph, and when a time interval within which the process may be required to traverse the edge to the next event-node passes, without the corresponding event having been received.

The residual process graph 1304 includes the remaining event-nodes and paths of the process graph of the stencil from the current event-node to the extant possible realities of the process stemming from the current event-node. In the example database record 1300, the monitored ‘Apples Order’ process has arrived at the ‘confirmed’ event-node in reality R(0, 2) in the process graph 304. As such the residual process graph 1304 stored in the database record 1300 includes the current ‘Confirmed’ event-node and the remaining event-nodes and paths to the extant realities. That is, the event-nodes corresponding to ‘cancelled’ and ‘refunded’ in ‘mex’ split reality R(0, 2, 3) in which the apples order is cancelled and a refund in received are included, as are the event-node corresponding to ‘delivered’ in ‘mex’ split reality R(0, 2, 4) in which the apples order is successfully delivered is included. Both realities are still possible outcomes (with respective weights 0.02 and 0.98) at the time of the generation of the database record 1300. However, referring back to the process graph 304 in the stencil 230 in FIG. 3, because the apples order has been ‘confirmed’ the reality R(0, 1) in which the order is instead abandoned is no longer an extant reality and so it is not included in the residual process graph 1304 in the database record 1300 shown in FIG. 13.

The process state record 1308 and attribute state records 1310a, 1310b and 1310c store a timestamp representing the information time for the transition to the current state of the process or attribute at the current event node, based on the schedule function for the process or the attribute. It should be noted that where the process or an attribute has not changed state as a result of the transition to the current event-node, and where the method called does not otherwise provide an update to the attribute (e.g. the expected value thereof), the state record provided in the database record 1300 for that attribute may correspond to the transition to the current state or when the attribute was last updated by the process object 232. That is, a new state record entry need not be added to every state record for each transition along the process graph.

For example, the process state record 1308 includes, in its last (bottommost) entry in the database record 1300, alongside an indication of the event-node ‘confirmed’ in the ‘node’ field, and the reality ‘R(2)’ in the ‘reality’ field, an indication of the information time ‘2025-01-03’ in the ‘time’ field, and the process state of ‘underway’ in the ‘state’ field. This indicates, in accordance with the process schedule function 308 in the stencil 230, that when the ‘Apple Order’ process is at the ‘confirmed’ event-node, the process is scheduled to be in the ‘underway’ state and has transitioned to that state. This reflects that the effects of the process are starting to manifest themselves in the real-world in that the order is happening and the supplier is presumably going about trying to fulfil it based on the terms of the order. However, there may yet be some refinement to some attribute values and timing, and also the outcome of the process is uncertain as the order may well be delivered (i.e. in R(0, 2, 4)), but it might yet be cancelled (i.e. in R(0, 2, 3)). It should be noted that this process state record 1308 entry is newly added in this database record 1300 because the process transitioned to this new ‘underway’ state on the transition to the ‘confirmed’ event-node, and so the time given in the ‘time’ field corresponds to the information time in the meta data 1302.

Similarly, the attribute state record 1310b for ‘cash-1’ (representing the cash payment for the apples), and attribute state record 1310a for ‘Apples’ (representing the number of delivered apples resulting from the order) include, in their last (bottommost) entry added in the database record 1300, alongside an indication of the event-node ‘confirmed’ in the ‘node’ field, and the reality ‘R(2)’ in the ‘reality’ field, an indication of the information time ‘2025-01-03’ in the ‘time’ field.

For attribute state record 1310b for ‘cash-1’, the attribute state of ‘done’ is indicated in the ‘state’ field. This indicates, in accordance with the attribute schedule function 310b in the stencil 230, that when the ‘Apple Order’ process is at the ‘confirmed’ event-node, the attribute ‘cash-1’ is scheduled to be in the ‘done’ state. This reflects that once the order is confirmed, the cash has been paid (or at least is committed to being paid) to the supplier for the order. By calling the ‘confirmed’ method, the Expected Value (i.e. the final value the attribute is currently expected to take) as indicated in the ‘E(V)’ field, is determined from the received arguments as (quantity*unit price)=120*−£0.50=−£60.00 (indicative of cash out). Here, because the ‘cash-1’ attribute is in the ‘done’ state, its value given in the ‘E(V)’ field is definitive, and no probability distribution is provided in the ‘Dist’ field. As such, the value given in ‘E(V)’ is a final, actual value manifested in the real world as a payment, and not an ‘expected value’, and it is not expected to be refined. It should be noted that this attribute state record 1310b entry is newly added in this database record 1300 because the ‘cash-1’ attribute transitioned to this new ‘done’ state on the transition to the ‘confirmed’ event-node, and so the time given in the ‘time’ field corresponds to the information time in the meta data 1302.

For attribute state record 1310a for ‘Apples’, the attribute state of ‘underway’ is indicated in the ‘state’ field. This indicates, in accordance with the attribute schedule function 310a in the stencil 230, that when the ‘Apple Order’ process is at the ‘confirmed’ event-node, the attribute ‘Apples’ is scheduled to be in the ‘underway’ state. This reflects that once the order is confirmed, and the cash has been paid (or at least is committed to being paid) to the supplier for the order, the supplier begins the process of fulfilling the order based on their stock of apples. However, based on experience, the supplier may have an uncertain stock of good apples, and may be inaccurate in the number of apples that are eventually delivered, which may be different from the ordered number as they may be measured out, e.g. by weight, and some may perish or be damaged in transit. To account for this uncertainty, while the Apple Order is still not in the ‘done’ state in the ‘delivered’ reality R(0, 2, 4) in which a definitive value for number of apples delivered is counted, the Apples attribute may be represented in the attribute state record 1310a and process object 232 by a probability distribution. That is, by calling the ‘confirmed’ method, and passing to it the argument ‘Quantity’, a probability distribution is generated for the Apples attribute corresponding to the normal distribution, centered on 120 (the ordered quantity), with a standard deviation of 5.5. This is represented in the ‘Dist’ field by N(120, 5.5).

A probability distribution is modelled for the process in this case because, we take a view that the supplier fulfilling the orders sometimes delivers quantities at variance to what is (a) ordered and (b) confirmed. This view can be driven by expert knowledge of how the apple ordering and fulfilment business typically operates, general and systematic views about the reliability of apple suppliers in general given current market conditions (similar to how credit spreads for bonds vary by rating, sector, . . . ), through to direct and empirical experience of working with the supplier and so on. Thus the distribution may be generated, e.g. based on empirical data, and may vary, for example, based on the specific supplier (which may be taken by the method as another argument) or other environmental data. The parameters and form of the modelled probability distributions for attributes are specified in the stencil 230 and methods 306. However, we might not know the exact form of the model, it might be forecast by some expert and external system: e.g. we merely need to provide the number of apples as input and it returns a modelled distribution for the number of apples we will receive.

Generally, the Expected Value (i.e. the most likely final value the attribute is currently expected to take) as indicated in the ‘E(V)’ field, may be determined from the generated probability distribution as the mean of the probability distribution. In the example shown, because the probability distribution is a normal distribution, the mean is the value on which it is centered, and so a value of 120 is indicated in the ‘E(V)’ field. However, because the ‘Apples’ attribute is in the ‘underway’ state, its value given in the ‘E(V)’ field is not definitive, and the final number of apples that may arrive may be different from the expected value, or no apples may arrive at all if the order is cancelled (in reality R(0, 2, 3). It should be noted that this attribute state record 1310a entry is newly added in this database record 1300 because the ‘Apples’ attribute transitioned to this new ‘underway’ state on the transition to the ‘confirmed’ event-node, and so the time given in the ‘time’ field corresponds to the information time in the meta data 1302.

For attribute state record 1310c for ‘cash-2’ (representing the cash payment that would be received for a refund of the apples in reality R(0, 2, 3)), the attribute state of ‘estimated’ is indicated in the ‘state’ field. This indicates, in accordance with the attribute schedule function 310c in the stencil 230, that when the ‘Apple Order’ process is at the ‘confirmed’ event-node, the attribute ‘cash-2’ is scheduled to still be in the ‘estimated’ state in which it was placed when the process first transitioned to the ‘init’ event-node. This reflects that once the order is initialized, it a refund is possible in the event the order is cancelled, but this is still at a low state of certainty as to whether it will materialise while the order is confirmed, reflected by the weight for the reality R(0, 2, 3) in which it does not vanish still being 0.02 and so highly unlikely, in the residual process graph 1304. Nevertheless, as the value of ‘cash-1’ is known as the payment has been made to the supplier, the value of the refund i.e. in the event the order is cancelled is also definitively known, even though the ‘cash-2’ attribute is still in the ‘estimated’ state. That is, once the order is ‘confirmed’ we expect no further variance in the value of cash, including in the reality where it is refunded even though the ‘cash-2’ attribute is still in the ‘estimated’ state.

Thus, by calling the ‘confirmed’ method, the value of ‘cash-2’ (i.e. the final value of any future refund) in the ‘E(V)’ field, is determined from the received arguments as (quantity*unit price)=120*+£0.50=+£60.00 (indicative of cash in), or simply as negative ‘cash-1’. Here, because the value of the ‘cash-2’ attribute is definitive, even though it is only in the ‘estimated’ state, no probability distribution is provided in the ‘Dist’ field. It should be noted that this attribute state record 1310c entry may be the only state record for ‘cash-2’ in this database record 1300 because the ‘cash-2’ attribute has not transitioned from the initial ‘estimated’ state on any of the transitions from the ‘init’ event-node to the ‘confirmed’ event-node. As such, the time indicated in the ‘time’ field corresponds to the time at which the ‘init’ method was called when the process object 232 was first initialized, on ‘2024-11-01’. However, the value given for the ‘cash-2’ attribute in the attribute state record 1310c corresponds to that definitive amount generated by calling the ‘confirmed’ method. In that respect, the value provided in the attribute state record 1310c for the database record 1300 may represent a refinement (in that the expected value of the refund may have been different at earlier event-nodes in the Apple Order process, such as at ‘init’ and ‘ordered’). In other embodiments, earlier entries may be provided for the ‘cash-2’ attribute state record 1310c in which the ‘cash-2’ attribute is still in the ‘estimated’ state, but the previous expected values (and probability distributions) for the refund may be provided. The time of the state transition to ‘estimated’ may still be provided, but the information time for the previous expected values (and probability distributions) of the previous entries may be included, indicating in the attribute state record 1310c the refinements to ‘cash-2’ attribute.

When a method refining the value of an attribute (or more generally, any and all attributes) is evaluated (whether or not an attribute state change is to be recorded) it may generally return and cause to be recorded in a new database record:
a single scalar value for the attribute (required for the final, done state, but optionally for lesser states); and/or
for an attribute still subject to uncertainty in state lower than the final, done state, it may return
   a set of possible values, and optionally probabilities, or
   more generally a probability distribution, whether analytic (for example, a normal distribution with a given mean and standard deviation) or empirical (e.g. a histogram).

This quantitative uncertainty is visible and well digitized in the block even without further division of the attribute according to space splitting described in earlier parts. However, the designer of the process graph may further subject the result to a space splitting of the attribute according to possible outcomes and their probabilities. Strictly speaking they're different attributes because they're in different realities anyway, but in the case of such a space split, it's contextually obvious that they're effectively the same attribute, forecast by the same function, but binned into different realities according to their possible outcomes.

In the example, as can be seen, the process state record 1308 and attribute state records 1310a, 1310b and 1310c also include a history of state record entries, for any and all previous states of the process and attribute the previous state of the process or attribute. The historical state records for the process and each attribute include at least a timestamp of the information time the process or attribute transitioned to the previous state, and, for each attribute, the expected value of the attribute of the process at the time of the transition to the previous state. Other information, such as the effective state at the time of the previous transition, the node, and also the probability distribution may be included. State record entries representing historical refinements not associated with a process or attribute state change may also be included.

As can be seen, in the process state record 1308, the current process state record entry is indicated in the ‘idx’ field with an index of ‘0’. The historical state record entries are indicated by earlier indexes in the ‘idx’ field, with negative integers indicating increasingly previous state or process graph event-node transitions. Thus, it is possible to see that, the Apple Order Process ID ‘1’, was initialised in the ‘estimated’ state on ‘2024 Nov. 1’, and transitioned to the ‘known’ state by being ordered on ‘2025-01-02’, which then transitioned to the current ‘underway’ state having been confirmed at the information time of ‘2025-01-03’.

Further, as can be seen in the attribute state record 1310a for the ‘Apples’ and attribute state record 1310b for ‘cash-1’, the current attribute state record entries are indicated in the ‘idx’ field with an index of ‘0’, and the historical state record entries are also indicated by earlier indexes in the ‘idx’ field, with negative integers indicating increasingly previous state or process graph event-node transitions. Thus, it is possible to see that, in the Apple Order Process ID ‘1’, the ‘Apples’ order was initialised into the ‘estimated’ state on ‘2024-11-01’ with a probability distribution of N(130, 5.7). This indicates that the order was originally envisaged on the basis of 130 apples being intended, and which at that time were expected with a probability distribution of N(130, 5.7). Subsequently, the ‘Apples’ attribute transitioned to the ‘known’ state on 2025-01-02 when the process transitioned to the ‘ordered’ node, with the same expected value. However, when the order was later confirmed on 2025-01-03, and the ‘Apples’ attribute transitioned to the ‘done’ state, the expected value changed to 120 apples in the order, having a probability distribution of N(120, 5.5).

On the other hand, the attribute state record 1310b for ‘cash-1’ was initialised into the ‘estimated’ state on ‘2024-11-01’ with a probability distribution of N(67, 2.9). This indicates that the originally envisaged order of 130 apples was expected to cost £67 with a probability distribution of N(67, 2.9). This implies a unit price of 51.5 pence at the time the order was initialised. Subsequently, the ‘cash-1’ attribute transitioned to the ‘known’ state on 2025-01-02 when the process transitioned to the ‘ordered’ node, this time with a probability distribution of N(62, 2.7). This indicates that the order of 130 apples was placed for £62 with a probability distribution of N(62, 2.7). This implies a unit price of 47.7 pence at the time the order was placed. However, we know that, when the order was later confirmed on 2025-01-03, the definitive value for ‘cash-1’ changed to £62, at a unit price of 50p. As can be seen the number of apples in the order and the unit price may value over time historically. The historical views of how the process and its attributes have evolved to their current state can thus be captured in a single database record.

Significantly, the schedule functions for the process and each attribute allow a decoupling of the state of the attributes from the state of the process, such that the state of each can progress through the sequence of states to completion at different stages. For example, at the ‘confirmed’ event-node in the process graph 304 for the ‘Apple Order’ process, the ‘cash-1’ attribute can be in the ‘done’ state, while the ‘Apples’ attribute and process as a whole are in the ‘underway’ state, and the ‘cash-2’ attribute is in the ‘estimated’ state. That is, there is a decoupling of the evolution of a process from data captured/digitized within in. In this respect, in the business management software system of the present disclosure, attributes (i.e. process data) and the process itself generally evolve separately from each other. The schedule functions are entirely about the lifecycle of the certainty of the attributes. An arbitrary number of use cases can be driven from one process because any number of attributes can be designed.

To provide further context for the evolution of the process up to the current information time, the database record 1300 may also include a reality history 1312 and an event history 1314. The reality history 1312 includes an indication of the realities the process has passed through indicated against the corresponding nodes in the process graph 304 that resulted in the reality splits. As can be seen from the reality history 1312, in the Apple Order Process ID ‘1’, the process occupied the original reality R(0) on initialization, but transitioned into reality R(0, 2) after the order was confirmed, meaning that the mutually exclusive reality R(0, 1), in which the order is not confirmed but instead abandoned is no longer reachable. In this regard, realities that were earlier possible (such as R(0, 1)) have been dropped (pruned out). To recover these “counterfactuals” requires visiting the prior database records 234 which include a residual process graph still including the pruned reality. It should be understood that, in the example database record 1300, the current reality R(0, 2) is an intermediate reality not a terminal reality for the process. However, the residual process graph 1304 indicates the extant terminal realities still available for the process to terminate in, i.e. reality R(0, 2, 3) in which the order is cancelled and refunded, and reality R(0, 2, 4) in which the apples are successfully delivered.

The event history 1314 includes an indication of the event-nodes the process has gone through on the path to the current event-node, and information times at which those events happened.

Thus, in this way, through the state records and residual process graph in particular, each generated database record may itself encapsulate a complete bitemporal view of the monitored process in its evolution over information time through the sequence of states up to the information time the record was created, with a view being able to be constituted for any effect time with respect to any information time (up to the present). For a given information time, for historical data, the historical state records and histories may be used to generate a backwards-looking view of the processes and the attributes at previous effect times, and, as will be explained in more detail below, based on the stored process graph and attribute values, a forward-looking view may be generated of the projected evolution of the monitored process for any future effect time taking into account uncertainty and path dependence. Historical state records do not store a weight. Weights are a forward-looking properties of the (residual) process graph.

To form backward- and forward-looking views of a process at different effect times, for a given information time, the data record for the process prevailing at the given information time needs to be retrieved from the store of database records 234. To facilitate this, and to facilitate the integrity, auditing and immutability of data, the process objects 232 may be configured to generate and store the database records 234 as immutable, denormalized blocks such as a block record as might be included in a blockchain.

To cause the process object 232 to generate an append-only contiguous chain of immutable blocks as a record of the progress of the monitored process, the process object 232 may generate the block record to include a reference to the most recently generated and stored block for the process, (i.e. if a block has previously been generated corresponding to a transition to an earlier event-node of the process).

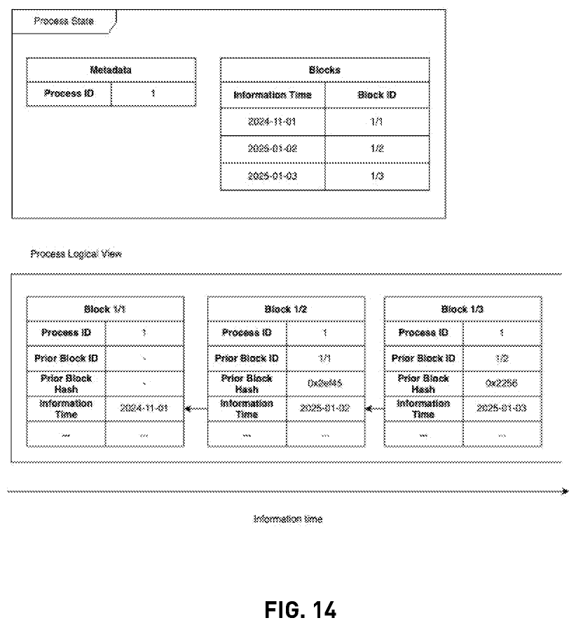

Such a chain of blocks—forming a blockchain—is shown in FIG. 14 for chain of block database records 234 generated for the ‘Apples Order’ process up to the database record 1300 shown in FIG. 13.

As can be seen in the meta data 1302 for the block database record 1300 shown in FIG. 13, a hash of the prior block is stored in the ‘prior block hash’ field as ‘0x2ef45’, together with indexing of the current Block ID in the ‘Block ID’ field as ‘⅓’ (meaning the third block of Process ID ‘1’), as well as an indication of the prior block in the ‘Prior Block ID’ field as ‘⅓’ (meaning the second block of Process ID ‘1’).

As can be seen in FIG. 14, a logical view of the process may be formed, in which the Prior Block ID and Prior Block Hash fields for each block database record allow validation of the chain of blocks.

Thus, as each of the instantiated process objects 232 monitors the progress of a related business process, a chain of (one or more) immutable, denormalized blocks is created and stored, each block linking to a previous block (if the block is not the first or only ‘genesis’ block) and thus creating in the store of database records 234 a backward linked list or chain of blocks for each instance of a business process.

In this way, each block in the chain of blocks provides a complete bitemporal ‘view’ of the progress of the monitored process at the time of the generation and storage of that block. The successive blocks in a chain do not have to correspond to sequentially increasing effect states, because states can be skipped, or refinement blocks can be added for the same effective state, when more information becomes known about the process, but events have not occurred to advance the process to the next (or later) effect state.

The process state, shown in FIG. 14, which may be stored separately for the process, may include metadata identifying the monitored process, and the IDs of the generated and stored block database records. The process state may also include keys or references to provide a map to facilitate location and retrieval of the blocks. In this way, the process object 232 or the process object manager 222 or query manager 224 can be used to identify and retrieve block database records from the chain of backwards-linked blocks stored in the store of database records 234.

Thus as the backward linking of the blocks establishes a list that can be navigated backwards. The process object data structure does not have to contain the blocks within itself in memory 204. However the process object does contain a map of information times to block identifiers. The map can only be appended to with information times strictly greater than the latest entry. A process is therefore always aware of all the blocks that it has created. It is also the container of business logic that creates new blocks. Therefore the process appears to contain the blocks.

The map of blocks (i.e. block list) may be stored in the memory 204 in relation to process object 232 and it may allow the block (if any) prevailing at any given information time to be found more rapidly than traversing the list of blocks, which may incur an I/O penalty for loading each block into memory. The keys in the map of blocks can be stored in a structure offering binary search of the keys, with complexity O(log n) for n the number of blocks, compared to O(n) for search by traversal of a singly linked list. However, the number of blocks for a given process is not large (of order 10) so even a simple array of tuples to support the map will suffice.

The first block of a chain of backwards-linked blocks is created with the creation of the process (i.e. instantiation of the process object and the initialization instruction sent thereto) at the information time corresponding to initialization. With the exception of the first block, each block references the preceding block in the process. A block prevails until a block succeeds it in the process. When something new is learned about the business process being monitored by a process object, the process object may transition the process or attributes to a later effect state, and/or refine the current state record and the future ones. As will be explained below, a correction to a historic state may also be occasioned by receipt of information in the event stream. However, as the list is append only, and the blocks, once created and stored are immutable, no operation ever mutates existing blocks. Operations can only append new blocks incorporating new information.

In this way, where blocks are used, the receipt of events for the monitored process thereby generates an append-only contiguous chain of immutable blocks as a record of the progress of the process, and each block being usable to determine, for at least the information time at which the block was generated, and based on the stored process graphs and attribute values, a forecast of the evolution of the monitored process for any future effect time.

Thus the database records 234 record the state of the process and information about the progress of knowledge about the process over time, in block form. The stored database records 234 may allow forward looking and backward looking bitemporal queries of the process state viewed from different information times, as the process state was or is expected to be for any given effect time. Each database record may itself individually encapsulate a complete bitemporal view of the process in its evolution over information time through the sequence of states up to the time the record was created, and, based on the stored process graph and attribute values, a forecast of the evolution of the monitored process for any future effect time.

By building up a store of database records 234 as a process progresses through states of increasing certainty to completion, different views of the overall business can be easily reconstituted for any time, based on the aggregated state of its processes and their effects on the affected attributes of business resources and assets, in a way that is not readily achievable using existing technologies.

The process objects 232 themselves may be configured, or the process object manager 222 may selectively cause each process object 232, to automatically transition the process to a next event-node in the process graph when a time interval within which the process may be expected to traverse the edge to the next event-node passes, without the corresponding event having been received. This may allow the automated operation of ‘self-executing’ processes.

That is, although, in the above-described, the initialization and transitioning instructions are predominantly envisaged as being sent out by the process object manager 222 to process object 232 responsive to events received in an event stream or queue, the process objects 232 may also be configured to operate in a decentralized and automated manner, acting as self-executing autonomous agents, such that a transition may also occur automatically, not in response to an event signal received in a stream or queue. That is, as described above, a process object is both data structure and code. To bring further benefits of scalability and resilience, the process objects may thus be configured to facilitate a de-centralized model of computation and data storage. The model of processes and blocks as described is well suited to a de-centralized infrastructure but can be further enhanced by considering and implementing processes as self-executing autonomous agents. That is to say that the process objects, thus configured are aware of their environment and respond to it in an automated manner, for example, in the respect of the prevailing information time, or they may be aware of other processes or timeseries.

Regarding closing a process, referring again to FIG. 12, while monitoring for signal events in the stream or queue, in steps 1202 and 1204, if no event is received matching a signal event for a monitored process, the business process monitoring and storage method 1200 proceeds to step 302 to determine whether any instructions have been received to close a process. If not, the business process monitoring and storage method 1200 continues back to step 1202, and the process continuously loops to monitor the event stream and for instructions to close processes.

A process object and the created chain of backwards-linked block database records 234 thus shares features with blockchains because each block record contains (a) a reference to the preceding block (which optionally may include a strong cryptographic hash), (b) a timestamp for the moment in time the block was created and (c) payload data (i.e. the fields stored in each block). The content of the block can be digitally signed to guarantee its integrity. Thus, in embodiments, the process object manager 222 may further be configured to store in each block as the reference to the previous block a cryptographic hash of the previous block, the blocks thereby forming an immutable blockchain for each process. In embodiments, the process object manager 222 may cause created blocks to be transmitted to a network of peer computing apparatus (such as a series of External systems servers 116 or Enterprise systems servers 110) each to validate and store copies of the created blocks, the network of peer nodes immutably storing the blockchain in a distributed ledger. This may further increase the integrity of the business management software system. It should be noted, however, that it is not required that the chains of blocks be managed on a peer-to-peer computer network where nodes on the network maintain replicas of the blockchain and agree by consensus that a block is valid, and that the existence of a multitude of nodes makes it practically impossible to mutate the content of a block across such a large number of nodes simultaneously.

Two alternative but complementary approaches which can be implemented by the query manager 224 to extracting, processing and collating responses to queries based on the retrieved database records are described herein. The first approach, described below in relation to FIG. 15, expands the residual process graphs stored in the retrieved database records by stepping forward along the process graphs, by determining the expected times for transition of any floating time intervals times, to determine the expected realities at the query effect time and associated likelihoods of materializing. The second approach, described below in relation to FIG. 17, augments or can be used as an alternative approach to that shown in FIG. 15, by using a simulation module 226 to explore the spectrum of potential outcomes to reveal a probability distribution across the future states of the business processes at the query effect time, using a Monte Carlo method.

The query manager 224 is provided to serve queries against the database records 234. That is, in response to receipt of a query, the relevant database records may be identified and retrieved from the store of database records 234 by the query manager 224, which may then extract, process and collate relevant data in order to generate a response to the query.

A detailed explanation of the operation of the query manager 224 software application of the business management software system disclosed herein will now be provided with reference to FIG. 15 which shows a query serving method 1500 for serving queries how data pertaining to business processes may evolve to possible and probable future states of the business processes.

It should be noted that, while the query serving method 1500 as described below focuses on the serving of forward-looking queries, it can also easily serve backward-looking queries in which the query effect time is earlier than the query information time, as the state records to that point are accumulated and we are on a certain reality.

Let's discuss the “forward” problem. ⋅An attribute can only exist on a particular reality. For any other reality it will vanish. So we only need to expand the reality where it survives, and calculate the probability of this happening. For example, we are in R( . . . , 36) and the attribute of interest is done in R( . . . , 36, 39, 45, 90). Any realities with indices different to this imply the attribute vanishes and do not need to be explored: E.g. (R . . . , 36, 39, 47). ⋅We only need to compute the events for the surviving reality up to the. A user probably doesn't want to query a particular single-reality attribute (Cash-1, Cash-2 etc) but Cash from all realities. But the point stands: we only need to explore that subset of realities where Cash-x does not vanish.

The query serving method 1500 starts in step 1502 by the query manager 224 receiving a query relating to one or more monitored business processes at a given query information time qᵢ, as to the possible future states of the business processes at a query effect time qₑ later than the query information time qᵢ. The query information time qᵢ may be the present information time tᵢ or any time before the present information time tᵢ.

Then, in step 1504, the query manager 224 causes to be retrieved from a database the most recent database records for each queried business process at or before the query information time. The database records may be retrieved from the store of database records 234 by the query manager 224, or another software module under instruction from the query manager 224, using a indexing and retrieval method implemented by the business management software system. Any suitable indexing system may be used that allows database records relevant to a query to be located and served to query manager 224. A detailed explanation of the database record indexing and retrieval mechanism is not needed here, and it is to be understood that the query manager 224 and other software modules 220 may be able to identify and retrieve desired database records from the store of database records 234 as needed.

Then, in step 1506, the query manager extracts from each retrieved database record all the attribute state records having a timestamp at or earlier than and nearest to the query effect time. That is, for a forward-looking query, generally the most recent attribute state records are retrieved.

The attribute value at the query effect time is then extracted given the information available in the retrieved database records 234. For all attributes that are done or vanished, and therefore already have definitive values, this is easy. For attributes which are ‘done’ (or ‘vanished’), everything about these attributes is a known fact. The weight is definitively 1 and there are no times to be computed from the graph. For attributes not yet ‘done’, but which are no longer subject to future path-dependence (and so the path of progression is certain and has a weight of 1), the residual process graph will need to be expanded to calculate the times of state transitions up to done. For attributes still subject to future path splits, the residual process graph needs to be similarly expanded and the reality in which those attributes can no longer vanish needs to be determined.

Thus, in step 1508, for attributes indicated in the extracted attribute state records as being not yet in the done state, the query manager 224 determines the reality the process may be scheduled to be in at the query effect time in which the attribute exists or the reality in which the attribute can no longer transition to a vanished state. This is achieved by the query manager 224 based on:
the schedule function for that attribute (as obtained from the corresponding stencil for the modelled process),
the expected time of transitions based on the time intervals in paths in the residual process graph in the corresponding database record, and
weights of edges in paths in the residual process graph in the corresponding database record.

To determine the expected time of transitions based on the time intervals in paths in the residual process graph, the query manager 224 may, for time intervals in paths in the residual process graph that are defined as floating time intervals (i.e. in which the process may be expected to transition to the next event-node along that path at any time within the floating time interval), determine the expected time at which the process may be expected to transition to the next event-node based on an appropriate probability distribution for the event occurring at different times during the floating time interval. The probability distribution may be a uniform or normal or log-normal probability distribution or any other suitable probability distribution. The probability distribution may be derived empirically or semi-empirically or based on a non-empirically assigned model. It may be stored in relation to the stencil or the database record.

Then, in step 1510, the query manager 224 determines a modelled likelihood of that reality in which the attribute exists materializing at the query effect time based on a compound weight of the edges to that reality in the residual process graph in the retrieved database records 234. For attributes indicated in the extracted attribute state records as being in the done state or for which there may be no future splitting left in the residual process graph, a likelihood of the reality in which the attribute exists materializing may be set to a weight of 1.

To generate the query response, in step 1512, the query manager 224 collates, for each attribute, at least the expected value for the attribute in the extracted attribute state record in the retrieved database records, the determined likelihood of the reality in which the attribute exists materializing at the query effect time. The response may also include the scheduled effect state for the attribute at the query effect time determined based on the time intervals in the residual process graph.

In this way, following the expansion of the residual process graph by calculating the timing of each event and splitting, and following the application of the schedule functions to the expanded graph for each reality for each attribute, the result is:
A list of realities, weights for each reality, and timings of all events;
The weight for each attribute (corresponding to the reality where they do not vanish);
The timing for each attribute to transition through future states, including the time of where an attribute may transition to vanished if such a possibility exists. This may be concatenated to the stack of historical state records (if any) for each attribute, thus creating a complete list of state records.
The timing for the process to transition through the states for each possible reality. This too may be joined with the historical state records for the process to create a complete list of state records.

Then create a view of each attribute at the user's specified query information time, the non-vanished attribute state record with time before the query effect time is found, and this record is paired with the weight for the reality in which the attribute does not vanish. The collation of this can provide the response to the forward-looking query.

While the attributes which have vanished are not reported in the query, because the information state for these attributes is vanished and their weight is zero, they are not “dropped” in that they do not just disappear as if deleted from existence. They were in non-vanished states beforehand. However, given the attributes have vanished and they contain no information, there is nothing to include about them in the query response.

Finally, in step 1514, the query manager 224 may serve the query response.

In step 1510, to determine a modelled likelihood of the reality in which the attribute exists materializing at the query effect time based on a compound weight of the edges to that reality, the query manager 224 may be configured to dynamically update the weights at a split based on the passage of time.

Specifically, the query manager 224 does this where the query information time intersects an edge in a path in the residual process graph having a time interval that is defined as a floating time interval (i.e. in which the process is expected to transition to the next event-node along that path at any time within the floating time interval), which edge, at the next event-node, leads to a time-based path split depending on whether or not the event is received by the end of the time interval. Where the event corresponding to the event-node has not yet been received by the query information time (and thus a transition has not happened) the query manager 224 calculates updated weights of the paths following the time split by determining, using Bayes theorem:
for the edge representing the event being received in time, the posterior probability of the event being received within the floating time interval taking into account the non-receipt of the event by the query information time; and
for the edge representing the event not being received in time, the posterior probability of the event not being received within the floating time interval taking into account the non-receipt of the event by the query information time.

This continuous updating mechanism ensures that the system accounts for the non-existence of information, leveraging principles akin to the Monty Hall problem to adjust probabilities accordingly. In more detail, in Bayesian inference, the posterior probability of a parameter given the passage of time can be updated using Bayes' theorem. The formula for Bayes' theorem, incorporating the passage of time as new information, is as follows. Let:
Θ be the parameter of interest
t be the time or the observed data up to time t
p(Θ) be the prior distribution of Θ
p(t|Θ) be the likelihood of observing data up to time t given Θ
p(t) be the marginal likelihood or evidence

The posterior probability p(Θ|t) given the passage of time t is:

$$p ( Θ \vert t ) = \frac{p ( t \vert Θ ) p ( Θ )}{p ( t )}$$

where the marginal likelihood p(t) is calculated as:

$$p ( t ) = \int p ( t \vert Θ ) p ( Θ ) d Θ$$

In this context:
p(Θ) represents our prior belief about the parameter Θ
p(t|Θ) represents the likelihood of the observed data up to time t given Θ
p(t) is the normalizing constant ensuring that the posterior distribution integrates to 1.

If we consider the passage of time and continuous updating of information, the likelihood function p(t|Θ) can be updated as new observations arrive over time. For example, suppose we have observations t₁, t₂, . . . , tₙ at times t₁, t₂, . . . , tₙ. The joint likelihood of these observations is:

$$p ( Θ \vert {t}_{1} , {t}_{2} , … , {t}_{n} ) = \frac{{\prod }_{i = 1}^{n} p ( {t}_{i} \vert Θ ) p ( Θ )}{p ( {t}_{1} , {t}_{2} , … , {t}_{n} )}$$

Thus, the posterior probability after n observations is:

$$p ( Θ \vert {t}_{1} , {t}_{2} , … , {t}_{n} ) = \frac{{\prod }_{i = 1}^{n} p ( {t}_{i} \vert Θ ) p ( Θ )}{p ( {t}_{1} , {t}_{2} , … , {t}_{n} )}$$

where the marginal likelihood p(t₁, t₂, . . . , tₙ) is:

$$p ( {t}_{1} , {t}_{2} , … , {t}_{n} ) = \int ( {\prod }_{i = 1}^{n} p ( {t}_{i} \vert Θ ) ) p ( Θ ) d Θ$$

This formulation allows for the posterior distribution p(Θ|t) to be updated continuously as new data arrives over time, ensuring that the inference process incorporates all available information up to the current time point. In scenarios where the only available information is the passing of time, this approach updates the weights at a path split along the residual process graph intersecting the query information time but before the query effect time to reflect the increased or decreased likelihood of certain outcomes. This probabilistic approach allows for a more nuanced and accurate representation of real-world processes, enabling better predictive modeling, decision making, and optimization of business workflows. By continuously refining these probabilities, the system can effectively manage uncertainty and provide insights that are both timely and contextually relevant.

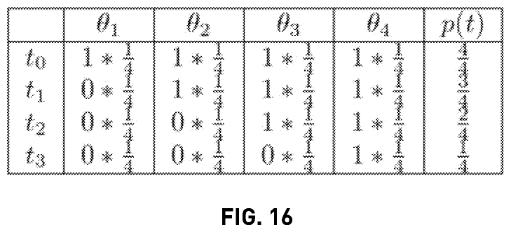

For example, with reference to FIG. 16, assume we want to calculate the probability of arrival of a shipment on any given day. We know for sure it will happen within the next N days. Without loss of generality, we assume a uniform probability distribution and that N=4 (although any suitable probability distribution that is adopted for the arrival time can be updated). After a day passes without its arrival, we update the posterior probabilities for the remaining days. Therefore,
Θ represents the hypothesis of arrival on a certain day;
p(Θ) is the a priori probability of Θ, initially ¼ in our example (as can be seen for t₀ in FIG. 16);
t is the observation that the shipment has not yet arrived by this day. This means the information of an event not happening is taken into account;
p(t|Θ) represents the likelihood of the shipment not arriving by day t given Θ, which is 1 for t before Θ, otherwise 0. Put another way: we observe t or we observe Θ. Given we observe Θ, i.e. the shipment has arrived, we cannot observe t any longer because t is the observation that the shipment has not yet arrived. So p(t|Θ) is 0 after Θ. The converse applies before Θ (the ship has arrived);
p(t) is the normalizing marginal probability, given in Table 2.3.

After one day passes without arrival (“event” t₁ has occurred), we can update the posterior probability for the arrival on any other day:

$$p ( Θ \vert {t}_{1} ) = \frac{p ( {t}_{1} \vert Θ ) p ( Θ )}{p ( {t}_{1} )} = \frac{1 * \frac{1}{4}}{\frac{3}{4}} = \frac{1}{3}$$

In this way, FIG. 16 shows a joint probability table for N=4 showing p(t|Θ)·p(Θ) for each combination of Θ and t, along with the marginal probability p(t) for each “event” t. The table illustrates the calculation of marginal probabilities used in applying Bayes' theorem.

Unlike floating time intervals, weights associated with fixed time intervals do not need to be updated. Consider, for example, the interval between ordered and confirmed in the ‘Apples Order’ process, which is fixed (“2 days”), the expectation time of the confirmed event does not change depending on how much time has passed since ordered while waiting for the event confirmed. While waiting for the confirmed event, the expectation time of the delivered event, which is based on a floating time interval does not change either.

When 2 days have passed and the confirmed event has still not arrived, this can be handled in a number of different ways. According to the parameterization, it was 100% certain that the event would happen in 2 days, so it is possible for the business management software system to assume it did happen, but we just didn't receive the event, and automatically transition the process. However, the process could be marked with the is_quarantined condition. In any case, it is possible that the parameterization for this transition in the process is incorrect, and the process could need to be adapted to cater for this.

However, once we have received the confirmed event, the “active interval” is this floating interval. While in this floating interval waiting for delivered the query manager 224 dynamically calculates the expectation time of the delivered event to reflect the passage of time.

Further, as noted, when such a floating time interval which leads to a time splitting is active the probability for being “in-time” decreases and “out-of-time” increases as time passes, and the query manager 224 updates the weights applying the principles of Bayesian renormalization as already described. Importantly, the business management software system does not take discrete timesteps forward to recalibrate these times and weights and generate a new snapshot of them, and new database records 234, as time elapses, which would lead to a proliferation of database records and extra data processing. Rather, this updating and inference is done by the query manager 224 on the fly at query time given the two arguments ti, qi. This allows the parameter qi to move forwards smoothly (continuously) and the user to obtain precisely re-computed expectation times and weights on demand while also reducing the increase in data footprint were the system to step forward discretely.

A detailed explanation of the operation of the simulation module 226 software application of the business management software system disclosed herein will now be provided. The query manager 224 may use simulation module 226 to operate a simulation method 1700 to explore the spectrum of potential outcomes to reveal a probability distribution across the future states of the business processes at the query effect time, using a Monte Carlo method.

The simulation method 1700 starts in step 1702 in which the query manager 224 receives a query relation to one or more monitored business processes at a given query information time qᵢ, as to the possible future states of the business processes at a query effect time qₑ later than the query information time qᵢ. The query information time qᵢ may be the present information time tᵢ or any time before the present information time tᵢ.

Then, in step 1704, the query manager 224 causes to be retrieved from a database the most recent database records for each queried business process at or before the query information time.

Then, in step 1706, the query manager extracts from each retrieved database record all the attribute state records having a timestamp at or earlier than and nearest to the query effect time. That is, for a forward-looking query, generally the most recent attribute state records are retrieved. These steps are the same as for the query serving method 1500.

However, in step 1708, the query manager 224 causes the simulation module 226 to, for attributes indicated in the extracted attribute state records as being not yet in the done state, and for each of a plurality of scenarios in a Monte Carlo method, determine, based on the schedule function for that attribute and the residual process graph in the corresponding database record, a simulated outcome of the modeled business process at the query effect time for that scenario.

The determination of the simulated outcome in the Monte Carlo method is achieved by stepping forward through the edges and the nodes in the residual process graph to simulate the progress of that modeled business process in that scenario by:
for each edge, determining a time at which the process may be simulated in that scenario to transition along the edge to the next event-node in the residual process graph by randomly sampling from an appropriate probability distribution for the time at which the process may be expected to transition to the next event-node, and
resolving any time splits based on the determined time, and
for each event-node at which the path splits, determining a path which the process may be simulated in that scenario to take by selecting, based on a random sample, a path based on the weights of edges following the split (this may be achieved for ‘space’ splits by sampling a probability distribution for the attribute values).

Stepping forward through the edges and the nodes in the residual process graph to simulate the progress of that modeled business process in that scenario may further include calling methods at each event-node encountered in that scenario to update the expected values of the attributes or the probability distributions for the attribute values.

In this way, the simulation module 226 can evolve the modelled process forward from its state at the query information time, to generate a number of simulated outcomes taking into account the uncertainty and path dependence. As before, the query manager 224 may dynamically update the weights of path splits where a floating time interval intersects the query information time, with the simulation module 226 sampling from the updated weights.

Then, in step 1710, the simulation module 226 determines, for the simulated progress of the modeled business process in each scenario, the reality the process is scheduled to be in at the query effect time and a simulated value for all attributes in that reality. The attribute values may be determined based on the expected values (as provided in the retried database record), or by randomly sampling a probability distribution for the attribute value.

In step 1712, the query manager 224 then generates a query response that collates, for each attribute and for each scenario, the simulated value for the attribute at the query effect time. A simulated effect state for the attribute at the query effect time, determined by the attribute schedule function and the simulated path through the residual process graph, may also be included. This collation thus generates a histogram which reveals a probability distribution for the simulated attribute values, and attribute states, at the query effect time, exploring all the different possible outcomes and realities.

Finally, in step 1714, the query manager 224 serves the query response in the appropriate form.

Thus a Monte Carlo simulation of the process (and all monitored processes in the business management software system) can be run because the database record contains the necessary information to sample the underlying distributions. With e.g. N=10,000 scenarios, this results in 10,000 possible scenarios for the process, with each one corresponding to a given reality (or “realization”). It is not necessary to run to conclusion, the simulation can stop at a given time horizon, e.g. corresponding to the query effect time. The result of such an exercise would be N possible outcomes (“realizations) for the business processes, each one randomly sampling paths, space (i.e. attribute probability distributions), and time.

In the Monte Carlo mode, where there are distributions recorded, whether analytic or empirical, they can be sampled. Crucially, this does not require the method and forecasting function to be re-evaluated (and these, in general, may be time consuming with unpredictable computations.)

Thus the stencil for the process and the database record specify distributions for parameters subject to future quantifiable uncertainty:
the spatial values of attributes;
the timing values for moving between nodes in the graph;
the probabilistic weights for following paths.

In the query serving method 1500, as the database records capture and store the expectation values for distributions, the process graph can be expanded and the attributes extracted correspond to expectation values in space, at expectations of time, labelled by the weight of the path/reality occurring. This approach allows forward evolutions of processes to see potential ‘Black Swan’ realities, even with very low weights, and as information arrives, so the weights to those realities may increase, or decrease in near real-time. These realities might not otherwise be seen with a Monte Carlo simulation for insufficient N.

The database records may thereby be usable to determine, for a given information time and based on the stored process graphs and attribute values, a forecast of the evolution of the monitored process for a future effect time. This is effectively through projecting the current data into the future through the process graphs to reveal a modelled probability distribution of the realities in which the process may be in at the future effect time, and expected values for the attributes in those realities. This may include exploring modelled probability distributions for the attributes and expected transition times.

An example of serving a bitemporal forward-looking query for the ‘Apples Order’ process, using the query serving method 1500 shown in FIG. 15 for the instance of the process as shown in FIG. 13 and FIG. 14 will now be described. Note that the example block in FIG. 13 represents the state of the process at 2025-01-03.

The query will first be served reasoning over the outcomes of the process graph 304 to determine the possible outcomes of the Apples Order at a future query effect time of qₑ=2025-01-31, viewed from a query information time of qᵢ=2024-11-01, i.e Qi0, (reflecting an information time of zero) the day on which the process is initialized. At the query effect time, the Apples Order process can be expected to have concluded regardless of how.

Thus at the query information time of 2024-11-01 the process is initialized (calling Init) for placing an order on 2025-01-02. J=62 days.

And like all scenarios, everything that we now say is a deduction from the process graph, this is not specification. Weights and expected time of transitions E (time) are computed at the point of extraction. For convenience we round up to units of days. For example, given a uniform probability distribution for a floating time interval, RoundUp (E(up to 5 days))=RoundUp(2.5 days)=3 days.

Once 1 day has passed in a floating time interval of “up to 2 days”, the E(time) for the next event is 1.5 days (i.e. next event occurs up to 2 days from TO, and given 1 day has passed . . . ). This is relevant to all floating time intervals, not just Bayesian weight renormalization for time splits.

In the Figures, event-nodes marked (*) are historic. The present reality is marked by (+)

The full timing information for R(0,1) is R(0)'s timing information and abandoned. The full timing information for R(0,2,4) is R(0)+R(0,2)+delivered. This reinforces the fact that realities with common indices have the same timing information (and event-nodes in the process graph) up to the point they split.

Now, following the query serving method 1500, we:
expand the graph in terms of realities and weights
assign times to all nodes
apply the schedule functions for each attribute and the process to the timeline for each reality to generate the (future) state records.

The graph of realities out to the query effect time (which in this case includes all terminal realities), and the compound weights for each reality are shown in FIG. 18. Note the sum of weights for the terminal realities R(0, 1), R(0, 2, 3) and R(0, 2, 4) is 1.

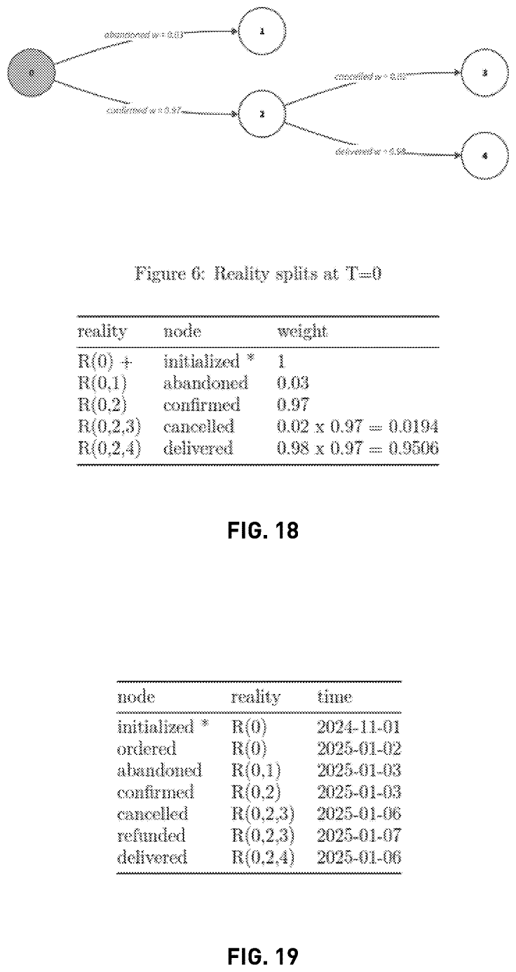

The expected time for the transitions to the different nodes in all the possible realities of the expanded process graph are shown in FIG. 19.

Note, the time for future events are expectation values, whereas the time for historic events is as realized.

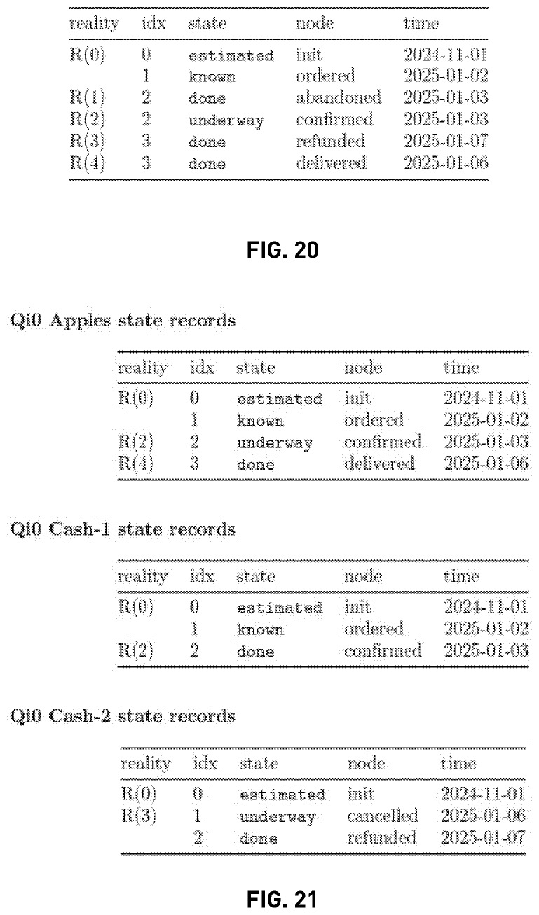

Next, each schedule function is applied to each reality's timing information. The process state record is shown for all realities in FIG. 20. The indices (idx) accumulate from the parent reality.

A complete path can be expressed as the accumulation of its “partial paths”. For example: R(0, 2, 4)=R(0)+R(2)+R(4), and state records for specific terminal realities can be constructed accordingly. Thus the state records to the terminal realities in which the attributes can no longer vanish are shown in FIG. 21.

We have expanded the graph, calculated the possible realities, their weights, and the timings of events on each reality. We have applied the schedule functions for each attribute to each reality to build up the state records that will result if that reality happens.

Now, to generate the query response, we pick out the state records that intersect with the query effect time. The information state and effective state can be used as filters.

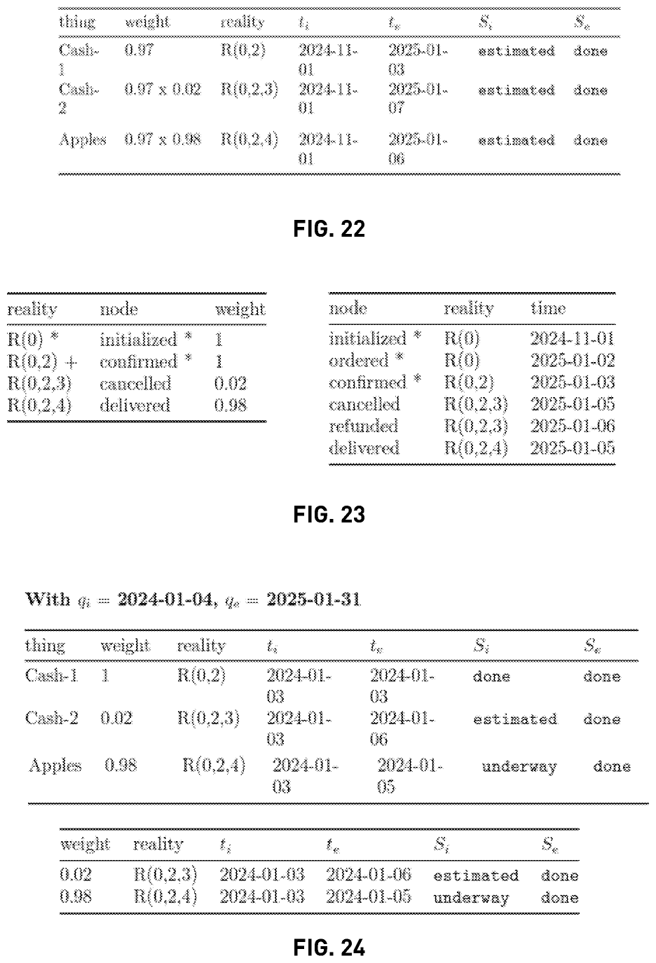

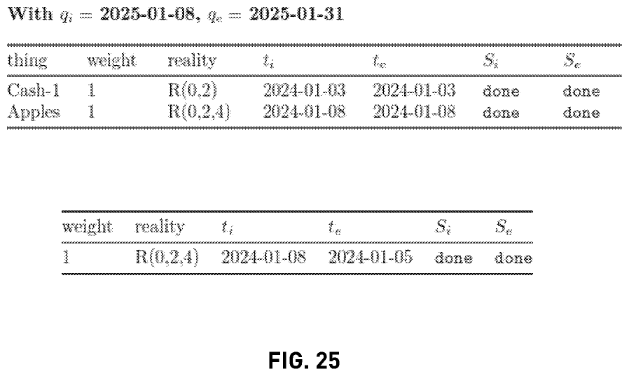

The collated response for the attribute weights is shown in FIG. 22. The ‘weight’ corresponds to the reality for the attribute to definitely not vanish (the reality where it can no longer transition to vanished). The process graph needs to be expanded as far as necessary so that we can calculate the eventual weights for each reality for each attribute being queried (in which the attribute is definitely not vanished, even if that reality lies after the query effect time).

For example, for the ‘Apples’ attribute, R(0, 2, 4) is the reality the weight must be calculated for. For any other “incompatible” resulting reality, there will be no apples, and they will be vanished. The user only needs the weight for the reality where they do not vanish, but is welcome to examine the weights and times for all the points (splits) where the attribute could vanish.

The weights are then combined with the expected values for the attributes and provided in the query response.

Another example bitemporal query will now be described by reasoning over the outcomes of the process graph 304 to determine the possible outcomes of the Apples Order at a future query effect time of qₑ=2025-01-31, viewed from a later query information time of qᵢ=2025-01-04, i.e Qi4, (reflecting an information time of 4-01-2025) the day on after which the has been confirmed. Again, at the query effect time, the Apples Order process can be expected to have concluded regardless of how.

In this scenario, the order was placed on 2025-01-02, and we received confirmation after 1 day on 2025-01-03. It's now one day after confirmation but the delivery has not yet arrived. The information time of the database record is tᵢ=2025-01-03. We are querying with time qᵢ=2025-01-04. In this case, the relevant database record to be retrieved and expanded thus corresponds to the database record 1300 shown in FIG. 13.

The realities (including the past) and the event timeline for Qi4 are shown side by side in FIG. 23.

In this case, the floating time interval up to time split (“t: up to 5 days”) needs to be renormalised. It's still 100% probable that the delivery will be received within 4 days (was 5 yesterday). The expectation time for the next node in the graph whether delivered or cancelled—is therefore 2 days from now: 2025-01-03+2=2025-01-05. This is shown in the expanded timeline of realities and events shown in FIG. 23.

If however 4 days had passed since confirmation (such that the query information time were 2025-01-07), leaving only one day for delivery/cancellation, then the expectation time of these events would be RoundUp (0.5)=1=> (2025-01-003+5)=2025-01-08, and the date of refund would be 2025-01-09. (The calculation doesn't “trip up over itself” when qi moves forwards.)

Going through the same process of generating the process and attribute state records, and then the weights for the different realities and attributes, the result of this query at query information time of qᵢ=2025-01-04, i.e Qi4 is shown in FIG. 24. Again, the expected values for the attributes can be taken from the retrieved database record 1300. Two realities are still possible: R(0, 2, 4) in which the apples are delivered and the ‘Apples’ attribute doesn't vanish (but ‘Cash-2’ does), and R(0, 2, 3) in which the order is cancelled and ‘Cash-2’ doesn't vanish (but ‘Apples’ does). ‘Cash-1’ is done, and so can not vanish and it has a weight of 1.

Finally, another example bitemporal query will now be described by reasoning over the outcomes of the process graph 304 to determine the possible outcomes of the Apples Order at a future query effect time of qₑ=2025-01-31, viewed from a yet later query information time of qᵢ=2025-01-08, i.e Qi8, (reflecting an information time of 8-01-2025) given delivery of the apples on 2025-01-08. Again, at the query effect time, the Apples Order process can be expected to have concluded regardless of how.

In this scenario, we received delivery on 2025-01-08. Note that this is as late as it could have been. No further events are expected, so the process must be done. Putting qᵢ or qₑ anywhere after 2025-01-08 will have no effect on the results. We are in reality R(0,2,4) (delivered). R(0,2,3) (cancelled and refunded) has been dropped.

Going through the same process of generating the process and attribute state records, and then the weights for the different realities and attributes, the result of this query at query information time of qᵢ=2025-01-08, i.e Qi8 is shown in FIG. 24.

Note, as there are no further splits, the weight of each of the non-vanished attributes ‘Apples’ and ‘Cash-1’, and the single reality R(0, 2, 4) is ‘1’. Cash 2 disappears as it has vanished from the current reality.

As has been seen, the process graph in each database record contains information about the possible and probable evolution of the data related to the monitored process, taking into account uncertainty and reality splits, and so allows forwards looking queries to be served, capturing reasoning as to the likely evolution of the future state of the business processes.

Notably, when the process graph is combined with the schedule functions, state, and bitemporality, it has the very useful effect of making possible future data visible. Further, when combined with the append-only immutable data structures of the block, this also allows arbitrary views in time (any query effect time qₑ) for any point in the information stream (information time t₁ and query information time qᵢ).

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. In particular, any dependent claims may be combined with any of the independent claims and any of the other dependent claims.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. Computing apparatus for monitoring and storing data in a structured data model pertaining to business processes, the structured data model capturing causal linkages in events making up the processes and being usable to serve reasoned responses to queries on how the data may evolve to possible and probable future states of the business processes, comprising:
one or more processors; and
memory storing a plurality of stencils, each stencil being for one of a plurality of business processes, each stencil being a homogeneously structured program-code template by which a processor may instantiate a process object to monitor progress of a process through a sequence of a predefined number of at least two discretized canonical states universal to each stencil for all modelled processes, the stencil defining:
a process graph for the modelled process represented by the stencil, the process graph comprising:
event-nodes representing:
events to be received by the computing apparatus in use as data messages in a stream or queue; or
the absence of receipt of a given event within a time interval;
wherein the events selected for the process graph include or infer information updating knowledge concerning the progress of the modelled business process; and
edges joining the event-nodes, the edges representing possible causal linkages of possible transitions between events;
wherein the process graph is arranged as a directed root tree encoding domain-specific prior knowledge about how the business process propagates from a root event-node at which the process is in a first, initial state to one or more leaf event-nodes defining one or more terminal mutually exclusive possible realities in which the process is considered to be in a final, done state, each edge being assigned a weight indicating the expected probability of monitored instances of the process transitioning from one event to another along a path to a given reality, each edge being further assigned a time interval within which the process is expected to traverse the edge to transition between the intersecting event-nodes;
one or more attributes for the modelled process; and
a respective schedule function for each attribute and for the process, each schedule function specifying a mapping of states to events in the event-nodes of the process graph causing a transition of the respective attribute or process to a corresponding state, wherein the states in sequence represent indicators of increasing certainty about the progress of the processes and their attribute values from the initial state of the process to the final, done state of the process;
the memory further storing instructions which when executed cause one or more of the processors to implement a process object manager to:
monitor events received as messages in a stream or queue;
in response to receipt of any event matching an event-node in the process graph of a stencil for a given business process, instruct a process object instantiated for the process based on the stencil for that process to transition to the corresponding event-node in the process graph, thereby causing the process object to generate and store in a database record at least:
a residual process graph including the remaining event-nodes and paths of the process graph of the stencil from the current event-node to the extant possible realities of the process stemming from the current event-node;
respective state records for the process and each attribute, the state records storing:
a timestamp representing the information time for the transition to the current event node;
the current state of the process or attribute at the current event node, based on the schedule function for the process or the attribute; and
for each attribute, a current expected value for each attribute of the process, updated based on information contained in the event and/or the stencil;
the receipt of events for the business processes thereby generating a database of records digitizing data pertaining to the business processes and usable to serve reasoned responses to queries on how the data may evolve to possible and probable future states of the business processes.

2. The computing apparatus of claim 1, the database records thereby being usable to determine, for a given information time and based on the stored process graphs and attribute values, a forecast of the evolution of the monitored process for a future effect time.

3. The computing apparatus of claim 1- or 2, wherein the stencils are configured such that the process graph for each process is configurable to comprise one or more path splits occurring at one or more event-nodes, reflecting that in different process objects instantiated to monitor different instances of the process, data messages can be received that cause the process graph of the process object to diverge by transitioning along different paths to distinct realities in a path-dependent manner from the root event-node along edges through different event-nodes to one or more leaf event-nodes existing in different realities.

4. The computing apparatus of claim 3, wherein the distinct realities in a process graph are indexed by a sequence of identifiers of the event-nodes in the path to that terminal event-node, the sequence of identifiers including at least those event-nodes at which path splits occurred, and wherein the instructions are further configured to cause the process object to generate and store in each database record a record of the reality history for the monitored process comprising the indexed sequence of identifiers to the current event-node.

5. The computing apparatus of claim 3- or 4, wherein the process graph is configured such that, at an event-node from which the process splits and proceeds along one or more different edges on different paths to distinct realities, the path along which an instance of the process proceeds is conditional on one or more criteria of the group comprising:
a time at which the event is received or by which the event is not received;
a value of some variable or attribute for the process prevailing at the time of receipt or non-receipt of the event;
which of a set of mutually exclusive possible events is received;
and wherein the instructions are further configured to cause the process object, when the process is at an event-node from which the process splits, to selectively transition along the available paths based on the criteria for that event-node to the corresponding event-node in the process graph.

6. The computing apparatus of claim 1, wherein the process graph and attribute schedule functions are configured such that each attribute belongs to a single reality such that, for that reality and realities stemming from all paths following from that reality, the attribute exists, and for processes that take a path that does not encompass the reality to which an attribute belongs, the existence of that attribute is deemed incompatible with those other realities, and the schedule function maps the attribute to a vanished state.

7. The computing apparatus of claim 1, wherein the process graph is constructed such that there is a unique path through the process graph of event-nodes and edges to any event-node.

8. The computing apparatus of claim 1, wherein the process graph is configured such that, within a reality the value of some variable, prevailing value of an attribute, of event data received for different instances of the process may fall within a range of tolerable possible values provided the causal consequences within the process are deemed immaterial and lead to compatible and consistent outcomes within that reality, and between different realities the data received for the process is such that the causal consequences within the process are deemed materially different leading to mutually exclusive outcomes between the different realities.

9. The computing apparatus of claim 1, wherein the possible realities for a given process are local to the process, and wherein the attribute values for the process within the possible realities may affect other, external processes.

10. The computing apparatus of claim 1, wherein the process graph may be configured to split at an event-node to transition along multiple paths that execute in parallel, wherein the paths of parallel execution are at least initially in the same reality.

11. The computing apparatus of claim 1, wherein the stencil for each modelled process comprises, for each event-node in the process graph, instructions defining a method as a function executable to initialize or update the expected value for attributes of the process based on information received in messages corresponding to events matching that event-node, wherein the methods in a stencil together constitute the domain model defined for the process, wherein the instructions are further configured to cause the process object, when an event is received corresponding to a transition to an event-node in the process graph for the monitored process, to call the method defined for that event-node passing arguments to the method based at least in part data related to the received event, the calling of the method optionally causing the process object to generate and store the record in the database.

12. (canceled)

13. (canceled)

14. The computing apparatus of claim 1, wherein the schedule functions for the process and each attribute construct the progress through the process as a state machine constructed as a directed acyclic graph, and having the states as nodes and the events representing the mapped event-nodes in the schedule functions as the edges, wherein the schedule function is such that the state cannot go backwards in the state machine towards the root of the directed acyclic graph.

15. The computing apparatus of claim 1, the instructions further causing the process object to generate and store, in the state records for the process and each attribute in each database record, for any and all previous states of the process and attribute:
the previous state of the process or attribute;
a timestamp of the information time the process or attribute transitioned to the previous state; and
for each attribute, the expected value of the attribute of the process at the time of the transition to the previous state; and
such that each generated database record itself encapsulates a complete bitemporal view of the process in its evolution over information time through the sequence of states up to the time the record was created, and, based on the stored process graph and attribute values, a forecast of the evolution of the monitored process for any future effect time.

16. The computing apparatus of claim 1, wherein the instructions further cause the process objects to generate, as the record stored in the database, an immutable, denormalized block, the block record further comprising:
if a block has previously been generated corresponding to a transition to an earlier event-node of the process, a reference to the most recently generated and stored block,
the receipt of events for the monitored process thereby generating an append-only contiguous chain of immutable blocks as a record of the progress of the process, and each block being usable to determine, for at least the information time at which the block was generated, and based on the stored process graphs and attribute values, a forecast of the evolution of the monitored process for any future effect time.

17. (canceled)

18. The computing apparatus of claim 1, further comprising instructions that may selectively cause each process object to automatically transition the process to a next event-node in the process graph when a time interval within which the process is expected to traverse the edge to the next event-node passes, without the corresponding event having been received.

19. A computing apparatus for serving reasoned responses to queries on how data pertaining to business processes may evolve to possible and probable future states of the business processes, comprising:
one or more processors; and
memory storing instructions which when executed cause one or more of the processors to implement a query manager to:
for a query received in relation to one or more monitored business processes at a given query information time, as to the possible future states of the business processes at a query effect time later than the query information time, cause to be retrieved from a database comprising a plurality of records, generated by operation of the computing apparatus of claim 1, of the state of progress of the business processes current at least until the query information time, the most recent data record for each queried business process at or before the query information time;
extract from each retrieved data record all the attribute state records having a timestamp at or earlier than and nearest to the query effect time;
for attributes indicated in the extracted attribute state records as being not yet in the done state:
determine, based on:
the schedule function for that attribute;
the expected time of transitions based on the time intervals in paths in the residual process graph in the corresponding database record; and
weights of edges in paths in the residual process graph in the corresponding database record,
the reality the process is scheduled to be in at the query effect time in which the attribute exists or the reality in which the attribute can no longer transition to a vanished state; and
determine a modelled likelihood of that reality in which the attribute exists materializing at the query effect time based on a compound weight of the edges to that reality;
and generate a query response that collates, for each attribute, at least the expected value for the attribute in the extracted attribute state record in the retrieved database records, the determined likelihood of the reality in which the attribute exists materializing at the query effect time, and optionally a scheduled effect state for the attribute at the query effect time determined based on the time intervals in the residual process graph.

20. The computing apparatus of claim 19, wherein for attributes indicated in the extracted attribute state records as being in the done state or for which there is no future splitting left in the residual process graph, likelihood of the reality in which the attribute exists materializing is set to a weight of 1.

21. The computing apparatus of claim 16, wherein, to determine the expected time of transitions based on the time intervals in paths in the residual process graph, the query manager is further configured to:
for time intervals in paths in the residual process graph that are defined as floating time intervals, in which the process is expected to transition to the next event-node along that path at any time within the floating time interval, determine the expected time at which the process is expected to transition to the next event-node based on an appropriate probability distribution, optionally a uniform probability distribution, for the event occurring at different times during the floating time interval.

22. The computing apparatus of claim 19, wherein, to determine a modelled likelihood of the reality in which the attribute exists materializing at the query effect time based on a compound weight of the edges to that reality, the query manager is further configured to:
for a query information time that intersects an edge in a path in the residual process graph having a time interval that is defined as a floating time interval in which the process is expected to transition to the next event-node along that path at any time within the floating time interval, which edge, at the next event-node, leads to a time-based path split depending on whether or not the event is received by the end of the time interval, where the event corresponding to the event-node has not yet been received by the query information time, calculate updated weights of the paths following the time split by determining, using Bayes theorem:
for the edge representing the event being received in time, the posterior probability of the event being received within the floating time interval taking into account the non-receipt of the event by the query information time; and
for the edge representing the event not being received in time, the posterior probability of the event not being received within the floating time interval taking into account the non-receipt of the event by the query information time.

23. (canceled)

24. (canceled)

25. (canceled)

26. Computer-implemented method for monitoring and storing data in a structured data model pertaining to business processes, the structured data model capturing causal linkages in events making up the processes and being usable to serve reasoned responses to queries on how the data may evolve to possible and probable future states of the business processes, the computer having access to a plurality of stencils, each stencil being for one of a plurality of business processes, each stencil being a homogeneously structured program-code template by which a processor may instantiate a process object to monitor progress of a process through a sequence of a predefined number of at least two discretized canonical states universal to each stencil for all modelled processes, the stencil defining:
a process graph for the modelled process represented by the stencil, the process graph comprising:
event-nodes representing:
events to be received by the computing apparatus in use as data messages in a stream or queue; or
the absence of receipt of a given event within a time interval;
wherein the events selected for the process graph include or infer information updating knowledge concerning the progress of the modelled business process; and
edges joining the event-nodes, the edges representing possible causal linkages of possible transitions between events;
wherein the process graph is arranged as a directed root tree encoding domain-specific prior knowledge about how the business process propagates from a root event-node at which the process is a first, initial state to one or more leaf event-nodes defining one or more terminal mutually exclusive possible realities in which the process is considered to be in a final, done state, each edge being assigned a weight indicating the expected probability of monitored instances of the process transitioning from one event to another along a path to a given reality, each edge being further assigned a time interval within which the process is expected to traverse the edge to transition between the intersecting event-nodes;
one or more attributes for the modelled process; and
a respective schedule function for each attribute and for the process, each schedule function specifying a mapping of states to events in the event-nodes of the process graph causing a transition of the respective attribute or process to a corresponding state, wherein the states in sequence represent indicators of increasing certainty about the progress of the processes and their attribute values from the initial state of the process to the final, done state of the process;
the method comprising:
monitoring events received as messages in a stream or queue;
in response to receipt of any event matching an event-node in the process graph of a stencil for a given business process, instructing a process object instantiated for the process based on the stencil for that process to transition to the corresponding event-node in the process graph, thereby causing the process object to generate and store in a database record at least:
a residual process graph including the remaining event-nodes and paths of the process graph of the stencil from the current event-node to the extant possible realities of the process stemming from the current event-node;
respective state records for the process and each attribute, the state records storing:
a timestamp representing the information time for the transition to the current event node;
the current state of the process or attribute at the current event node, based on the schedule function for the process or the attribute; and
for each attribute, a current expected value of the or each attribute for the process, updated based on information contained in the event and/or the stencil;
the receipt of events for the business processes thereby generating a database of records digitizing data pertaining to the business processes and usable to serve reasoned responses to queries on how the data may evolve to possible and probable future states of the business processes.

27-31. (canceled)
